(19) United States
(12) Patent Application Publication
(10) Pub. No.: US 2026/0071014 A1
(43) Pub. Date: Mar. 12, 2026

(54) GROUP III-HALIDE OR LANTHANIDE-HALIDE BIS(PHENYLPHENOXY) METAL-LIGAND COMPLEXES

(71) Applicant: Dow Global Technologies LLC, Midland, MI (US)

(72) Inventors: Rhett A. Baillie, Missouri City, TX (US); Johnathan E. DeLorbe, Manvel, TX (US); Endre Szuromi, Lake Jackson, TX (US); Philip P. Fontaine, Pearland, TX (US); Robert D. Grigg, Midland, MI (US); Sudipta Pal, Midland, MI (US); Jerzy Klosin, Midland, MI (US); Brad C. Bailey, Midland, MI (US)

(73) Assignee: Dow Global Technologies LLC, Midland, MI (US)

(21) Appl. No.: 19/105,251

(22) PCT Filed: Aug. 29, 2023
(86) PCT No.: PCT/US2023/073084

§ 371 Date: Feb. 20, 2025

Related U.S. Application Data
(60) Provisional application No. 63/401,915, filed on Aug. 29, 2022.

(51) Int. Cl. C08F 210/16; C07F 5/00; C07F 7/08

(52) U.S. Cl. CPC C08F 210/16; C07F 5/003; C07F 7/0812

(57) ABSTRACT

Embodiments of this disclosure are directed to catalyst systems comprising a metal-ligand complex according to formula (I).

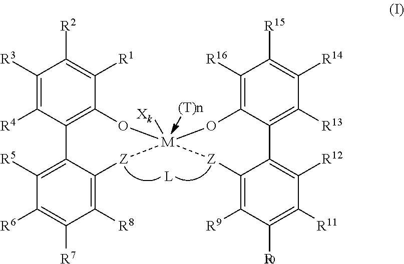

### CROSS-REFERENCE TO RELATED APPLICATIONS

This application claims priority to U.S. Provisional Application No. 63/401,915 filed Aug. 29, 2022, the entirety of which is incorporated by reference herein.

### TECHNICAL FIELD

Embodiments of the present disclosure generally relate to olefin polymerization catalyst systems and processes and, more specifically to bis-phenylphenoxy metal-ligand complexes having a Group III or Lanthanide metal center.

### BACKGROUND

Olefin-based polymers such as polyethylene, ethylene-based polymers, polypropylene, and propylene-based polymers are produced via various catalyst systems. Selection of such catalyst systems used in the polymerization process of the olefin-based polymers is an important factor contributing to the characteristics and properties of such olefin-based polymers.

Ethylene-based polymers and propylene-based polymers are manufactured for a wide variety of articles. The polyethylene and polypropylene polymerization process can be varied in a number of respects to produce a wide variety of resultant polyethylene resins having different physical properties that render the various resins suitable for use in different applications. The ethylene monomers and, optionally, one or more co-monomers are present in liquid diluents or solvents, such as alkanes or isoalkanes, of which hexane and isobutane are specific examples. Hydrogen may also be added to the reactor. The catalyst systems for producing ethylene-based may typically comprise a chromium-based catalyst system, a Ziegler-Natta catalyst system, and/or a molecular (either metallocene or non-metallocene (molecular)) catalyst system. The reactants in the catalyst system and the diluent are circulated at an elevated polymerization temperature within the reactor, thereby producing ethylene-based homopolymer or copolymer. Either periodically or continuously, part of the reaction mixture is removed from the reactor, including the polyethylene product dissolved in the diluent, and unreacted ethylene and one or more optional co-monomers. The reaction mixture may be processed after removal from the reactor to remove the polyethylene product from the diluent and the unreacted reactants, and the diluent and unreacted reactants are typically recycled back into the reactor. Alternatively, the reaction mixture may be sent to a second reactor, serially connected to the first reactor, where a second polyethylene fraction may be produced. Despite the research efforts in developing catalyst systems suitable for olefin polymerization, such as polyethylene polymerization, there is still a need to increase the efficiencies of catalyst systems that are capable of producing polymer with high molecular weights a narrow molecular weight distribution, and high selectivity towards ethylene.

With previous discovered Group III bis-phenylphenoxy metal-ligand catalysts, the catalyst did not require a co-catalyst or activator to begin polymerization. While not requiring a co-catalyst or activator may be beneficial, it also presents problems within the reactor. Due to the reactivity of the Group III bis-phenylphenoxy metal-ligand catalysts, the catalysts may react in the feedline or as soon as the Group III catalysts come into contact with ethylene, and thereby fouling the injection site or feedline.

### SUMMARY

There is an ongoing need to create catalyst systems or metal-ligand complexes with a high selectivity toward ethylene during ethylene and α-olefin copolymerization reactions. Additionally, the metal-ligand complex should have high catalyst efficiency, and a versatile ability to produce polymers with a high or low molecular weight at high temperature (such as greater than 140° C. or approximately 190° C.).

Embodiments of this disclose provide a chloro-scandium-bis(phenylphenoxyl) metal-ligand complex that is unreactive until the chlorine atom is replaced with an alkyl group, rendering the metal-ligand complex an active catalyst.

Embodiments of this disclosure include a catalyst system comprising a metal-ligand complex according to formula (I):

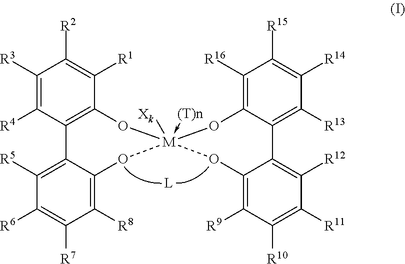

In formula (I), M is scandium, yttrium, a lanthanide metal or an actinide metal having an oxidation state of +3. Subscript n of (T) n is 0, 1, or 2; X is a halogen atom, and subscript k is 1 or 2. T is a Lewis base. The metal-ligand complex is overall charge-neutral.

In formula (I), R¹ and R¹⁶ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, halogen, radicals having formula (II), radicals having formula (III), and radicals having formula (IV):

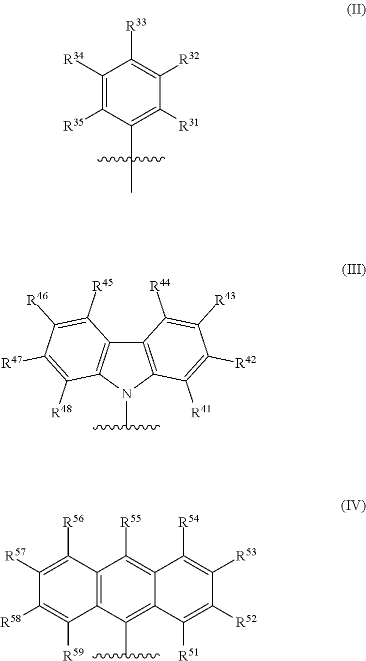

In formulas (II), (III), and (IV), each of R31-35, R41-48, and R51-59 is independently chosen from —H, (C1□C40)hydrocarbyl, (C1□C40)heterohydrocarbyl, —Si(RC)₃, —Ge(RC)3, —P(RP)2, —N(RN)2, —ORC, —SRC, —NO₂, —CN, —CF3, RCS(O)—, RCS(O)2-, (RC)2C═N—, RCC(O)O—, RCOC(O)—, RCC(O)N(RN)—, (RC)2NC(O)—, or halogen.

In formula (I), R2, R3, R4, R5, R6, R7, R8, R9, R10, R11, R12, R13, R14, and R15 is independently selected from —H, (C1□C40)hydrocarbyl, (C1□C40)heterohydrocarbyl, —Si(RC)3, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen.

In formulas (I), (II), (III), and (IV), each R^{C}, R^{P}, and R^{N} is independently a (C₁-C₃₀)hydrocarbyl, (C₁-C₃₀)heterohydrocarbyl, or —H.

### DETAILED DESCRIPTION

Specific embodiments of catalyst systems will now be described. It should be understood that the catalyst systems of this disclosure may be embodied in different forms and should not be construed as limited to the specific embodiments set forth in this disclosure.

Common abbreviations are listed below:

R, Z, M, X and n: as defined above; Me: methyl; Et: ethyl; Ph: phenyl; Bn: benzyl; i-Pr: iso-propyl; t-Bu: tert-butyl; t-Oct: tert-octyl (2,4,4-trimethylpentan-2-yl); Tf: trifluoromethane sulfonate; CV: column volume (used in column chromatography); EtOAc: ethyl acetate; TEA: triethylaluminum; MAO: methylaluminoxane; MMAO: modified methylaluminoxane; LiCH₂TMS: (trimethylsilyl)methyllithium; TMS: trimethylsilyl; Pd(AmPhos)Cl₂: Bis(di-tert-butyl(4-dimethylaminophenyl)phosphine)dichloropalladium (II); Pd(AmPhos): Chloro(crotyl)(di-tert-butyl(4-dimethylaminophenyl)phosphine)palladium (II); Pd(dppf)Cl₂: [1,1′-Bis(diphenylphosphino) ferrocene]palladium (II) dichloride; ScCl₃: scandium (III) chloride; PhMe: toluene; THF: tetrahydrofuran; CH₂Cl₂: dichloromethane; DMF: N,N-dimethylformamide; EtOAc: ethyl acetate; Et₂O: diethyl ether; MeOH: methanol; NH₄Cl: ammonium chloride; MgSO₄: magnesium sulfate; Na₂SO₄: sodium sulfate; NaOH: sodium hydroxide; brine: saturated aqueous sodium chloride; SiO₂: silica; CDCl₃: chloroform-D; GC: gas chromatography; LC: liquid chromatography; NMR: nuclear magnetic resonance; MS: mass spectrometry; mmol: millimoles; mL: milliliters; M: molar; min or mins: minutes; h or hrs: hours; d: days; TLC; thin layered chromatography; rpm: revolution per minute; rt: room temperature.

The term “independently selected” is used herein to indicate that the R groups, such as, R¹, R², R³, R⁴, and R⁵, can be identical or different (e.g., R¹, R², R³, R⁴, and R⁵ may all be substituted alkyls or R¹ and R² may be a substituted alkyl and R³ may be an aryl, etc.) A chemical name associated with an R group is intended to convey the chemical structure that is recognized in the art as corresponding to that of the chemical name. Thus, chemical names are intended to supplement and illustrate, not preclude, the structural definitions known to those of skill in the art.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀)alkyl is an alkyl group having from 1 to 50 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent. The term “—H” means a hydrogen or hydrogen radical that is covalently bonded to another atom. “Hydrogen” and “—H” are interchangeable, and unless clearly specified have identical meanings.

The term “(C₁-C₅₀)hydrocarbyl” means a hydrocarbon radical of from 1 to 50 carbon atoms and the term “(C₁-C₅₀)hydrocarbylene” means a hydrocarbon diradical of from 1 to 50 carbon atoms, in which each hydrocarbon radical and each hydrocarbon diradical is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S} or unsubstituted.

In this disclosure, a (C₁-C₅₀)hydrocarbyl may be an unsubstituted or substituted (C₁-C₅₀)alkyl, (C₃-C₅₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene (such as benzyl (—CH₂-C₆H₅)).

The terms “(C₁-C₅₀)alkyl” and “(C₁-C₁₈)alkyl” mean a saturated straight or branched hydrocarbon radical of from 1 to 50 carbon atoms and a saturated straight or branched hydrocarbon radical of from 1 to 18 carbon atoms, respectively, that is unsubstituted or substituted by one or more R^{S}. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl, 2-methylpropyl; 1,1-dimethylethyl; 1-pentyl; 1-hexyl: 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl.

The term “(C₆-C₅₀)aryl” means an unsubstituted or substituted (by one or more R^{S}) monocyclic, bicyclic, or tricyclic aromatic hydrocarbon radical of from 6 to 40 carbon atoms, of which at least from 6 to 14 of the carbon atoms are aromatic ring carbon atoms. A monocyclic aromatic hydrocarbon radical includes one aromatic ring; a bicyclic aromatic hydrocarbon radical has two rings; and a tricyclic aromatic hydrocarbon radical has three rings. When the bicyclic or tricyclic aromatic hydrocarbon radical is present, at least one of the rings of the radical is aromatic. The other ring or rings of the aromatic radical may be independently fused or non-fused and aromatic or non-aromatic. Examples of unsubstituted (C₆-C₅₀)aryl include: unsubstituted (C₆-C₂₀)aryl, unsubstituted (C₆-C₁₈)aryl; 2-(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl include: substituted (C₁-C₂₀)aryl; substituted (C₆-C₁₈)aryl; 2,4-bis([C₂₀]alkyl)-phenyl; polyfluorophenyl; pentafluorophenyl; and fluoren-9-one-1-yl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, cyclopentanon-2-yl, and 1-fluorocyclohexyl.

Examples of (C₁-C₅₀)hydrocarbylene include unsubstituted or substituted (C₆-C₅₀)arylene, (C₃-C₅₀)cycloalkylene, and (C₁-C₅₀)alkylene (e.g., (C₁-C₂₀)alkylene) The diradicals may be on the same carbon atom (e.g., —CH₂—) or on adjacent carbon atoms (i.e., 1,2-diradicals), or are spaced apart by one, two, or more than two intervening carbon atoms (e.g., 1,3-diradicals, 1,4-diradicals, etc.). Some diradicals include 1,2-, 1,3-, 1,4-, or an α,ω-diradical, and others a 1,2-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e. —CH₂CH₂CH₂—), 2-methylpropan-1,3-diyl (i.e. —CH₂CH(CH₃)CH₂—). Some examples of (C₆-C₅₀)arylene α,ω-diradicals include phenyl-1,4-diyl, napthalen-2,6-diyl, or napthalen-3,7-diyl.

The term “(C₁-C₅₀)alkylene” means a saturated straight chain or branched chain diradical (i.e., the radicals are not on ring atoms) of from 1 to 50 carbon atoms that is unsubstituted or substituted by one or more R^{S}. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, (CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and —(CH₂)₁₄C(CH₃)₂ (CH₂)₅— (i.e., a 6,6-dimethyl substituted normal-1,20-eicosylene). Since as mentioned previously two R^{S} may be taken together to form a (C₁-C₁₈)alkylene, examples of substituted (C₁-C₅₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis (methylene)bicyclo[2.2.2]octane.

The term “(C₃-C₅₀)cycloalkylene” means a cyclic diradical (i.e., the radicals are on ring atoms) of from 3 to 50 carbon atoms that either is unsubstituted or is substituted by one or more R^{S}.

The term “heteroatom,” refers to an atom other than hydrogen or carbon. Examples of groups containing one or more than one heteroatom include O, S, S(O), S(O)₂. Si(R^{C})₂, P(R^{P}), N(R^{N}), —N═C(R^{C})₂, —Ge(R^{C})₂—, —Si(R^{C})—, boron (B), aluminum (Al), gallium (Ga), or indium (In), where each R^{C} and each R^{P} is unsubstituted (C₁-C₁₈)hydrocarbyl or —H, and where each R^{N} is unsubstituted (C₁-Cia)hydrocarbyl. The term “heterohydrocarbon” refers to a molecule or molecular framework in which one or more carbon atoms of a hydrocarbon are replaced with a heteroatom. The term “(C₁-C₅₀)heterohydrocarbyl” means a heterohydrocarbon radical of from 1 to 50 carbon atoms, and the term “(C₁-C₅₀)heterohydrocarbylene” means a heterohydrocarbon diradical of from 1 to 50 carbon atoms. The heterohydrocarbon of the (C₁-C₅₀)heterohydrocarbyl or the (C₁-C₅₀)heterohydrocarbylene has one or more heteroatoms. The radical of the heterohydrocarbyl may be on a carbon atom or a heteroatom. The two radicals of the heterohydrocarbylene may be on a single carbon atom or on a single heteroatom. Additionally, one of the two radicals of the diradical may be on a carbon atom and the other radical may be on a different carbon atom; one of the two radicals may be on a carbon atom and the other on a heteroatom; or one of the two radicals may be on a heteroatom and the other radical on a different heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₅₀)heterohydrocarbyl may be unsubstituted or substituted. Non-limiting examples of the (C₁-C₅₀)heterohydrocarbyl include (C₁-C₅₀)heteroalkyl, (C₁-C₅₀)hydrocarbyl-O—, (C₁-C₅₀)hydrocarbyl-S—, (C₁-C₅₀)hydrocarbyl-S(O)—, (C₁-C₅₀)hydrocarbyl-S(O)₂—, (C₁-C₅₀)hydrocarbyl-Si(R^{C})₂—, (C₁-C₅₀)hydrocarbyl-N(R^{N})—, (C₁-C₅₀)hydrocarbyl-P(R^{P})—, (C₂-C₅₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₅₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₁-C₅₀)heteroaryl” means an unsubstituted or substituted (by one or more R^{S}) mono-, bi-, or tricyclic heteroaromatic hydrocarbon radical of from 1 to 50 total carbon atoms and from 1 to 10 heteroatoms. A monocyclic heteroaromatic hydrocarbon radical includes one heteroaromatic ring; a bicyclic heteroaromatic hydrocarbon radical has two rings; and a tricyclic heteroaromatic hydrocarbon radical has three rings. When the bicyclic or tricyclic heteroaromatic hydrocarbon radical is present, at least one of the rings in the radical is heteroaromatic. The other ring or rings of the heteroaromatic radical may be independently fused or non-fused and aromatic or non-aromatic. Other heteroaryl groups (e.g., (Cₓ-C_{y})heteroaryl generally, such as (C₁-C₁₂)heteroaryl) are defined in an analogous manner as having from x to y carbon atoms (such as 1 to 12 carbon atoms) and being unsubstituted or substituted by one or more than one R^{S}. The monocyclic heteroaromatic hydrocarbon radical is a 5-membered ring or a 6-membered ring. The 5-membered ring monocyclic heteroaromatic hydrocarbon radical has 5 minus h carbon atoms, where h is the number of heteroatoms and may be 1, 2, 3, or 4; and each heteroatom may be O, S, N, or P. Examples of 5-membered ring heteroaromatic hydrocarbon radicals include pyrrol-1-yl; pyrrol-2-yl; furan-3-yl; thiophen-2-yl; pyrazol-1-yl, isoxazol-2-yl; isothiazol-S-yl, imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl, tetrazol-2-yl; and tetrazol-5-yl. The 6-membered ring monocyclic heteroaromatic hydrocarbon radical has 6 minus h carbon atoms, where h is the number of heteroatoms and may be 1 or 2 and the heteroatoms may be N or P. Examples of 6-membered ring heteroaromatic hydrocarbon radicals include pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f]indol-1-yl. An example of the fused 6,5,6-ring system is 9H-carbazol-9-yl. An example of the fused 6,6,6-ring system is acrydin-9-yl.

The term “(C₁-C₅₀)heteroalkyl” means a saturated straight or branched chain radical containing one to fifty carbon atoms and one or more heteroatom. The term “(C₁-C₅₀)heteroalkylene” means a saturated straight or branched chain diradical containing from 1 to 50 carbon atoms and one or more than one heteroatoms. The heteroatoms of the heteroalkyls or the heteroalkylenes may include Si(R^{C})₃, Ge(R^{C})₃, Si(R^{C})₂, Ge(R^{C})₂, P(R^{P})₂, P(R^{P}), N(R^{N})₂, N(R^{N}), N, O, OR^{C}, S, SR^{C}, S(O), and S(O)₂, wherein each of the heteroalkyl and heteroalkylene groups are unsubstituted or are substituted by one or more R^{S}.

Examples of unsubstituted (C₂-C₄₀)heterocycloalkyl include unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may be present in substituents R^{S}. The term “unsaturated” means containing one or more carbon-carbon double bonds or carbon-carbon triple bonds, or (in heteroatom-containing groups) one or more carbon-nitrogen double bonds, carbon-phosphorous double bonds, or carbon-silicon double bonds, not including double bonds that may be present in substituents R^{S}, if any, or in aromatic rings or heteroaromatic rings, if any.

The term “lanthanide metal” includes elements 57 through 71 (lanthanum (La) to lutetium (Lu)).

Embodiments of this disclosure include catalyst systems that include a metal-ligand complex according to formula (I):

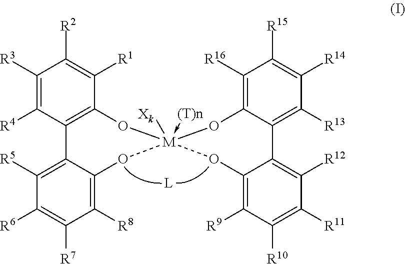

In formula (I), M is scandium, yttrium, a lanthanide metal. Subscript n of (T) n is 0, 1, or 2; X is a halogen atom, and subscript k is 1 or 2. Each R^{C} is independently a substituted or unsubstituted (C₁-C₃₀)hydrocarbyl, or a substituted or unsubstituted (C₁-C₃₀)heterohydrocarbyl. T is a Lewis base. The metal-ligand complex is overall charge-neutral.

In formula (I), R¹ and R¹⁶ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, halogen, radicals having formula (II), radicals having formula (III), and radicals having formula (IV):

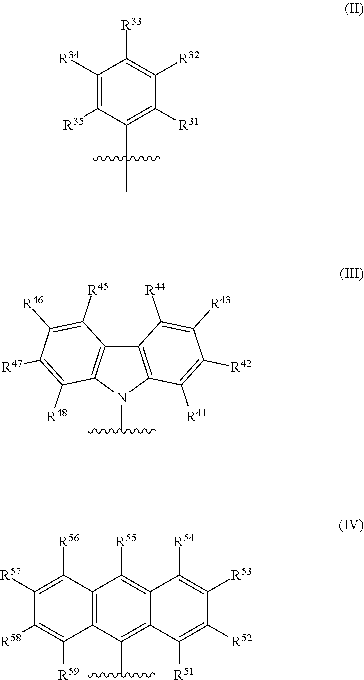

In some embodiments, in the metal-ligand complex of formula (I), either one of R¹ or R¹⁶, or both R¹ and R¹⁶, are chosen from radicals having formula (II), formula (III), or formula (IV). With the proviso that when M is yttrium or a lanthanide metal, R¹ is not —H, phenyl or tert-butyl; and R¹⁶ is not —H, phenyl or tert-butyl.

When present in the metal-ligand complex of formula (I) as part of a radical having formula (II), formula (III), or formula (IV), the groups R³¹⁻³⁵, R⁴¹⁻⁴⁸, and R⁵¹⁻⁵⁹ of the metal-ligand complex of formula (I) are each independently chosen from (C₁-C₄₀)hydrocarbyl, (C₁-C₄₀)heterohydrocarbyl, Si(R^{C})₃, P(R^{P})₂, N(R^{N})₂, OR^{C}, SR^{C}, NO₂, CN, CF₃, R^{C}S(O)—, R^{C}S(O)₂—, (R^{C})₂C—N—, R^{C}C(O)O—, R^{C}OC(O)—, R^{C}C(O)N(R^{N})—, (R^{N})₂NC(O)—, halogen, hydrogen (—H), or combinations thereof. Independently each R^{C}, R^{P}, and R^{N} are unsubstituted (C₁-C₁₈)hydrocarbyl, (C₁-C₃₀)heterohydrocarbyl, or —H.

The groups R¹ and R¹⁶ in the metal-ligand complex of formula (I) are chosen independently of one another. For example, R¹ may be chosen from a radical having formula (II), (III), or (IV) and R¹⁶ may be a (C₁-C₄₀)hydrocarbyl; or R¹ may be chosen from a radical having formula (II), (III), or (IV) and R¹⁶ may be chosen from a radical having formula (II), (III), or (IV) the same as or different from that of R¹. Both R¹ and R¹⁶ may be radicals having formula (II), for which the groups R³¹⁻³⁵ are the same or different in R¹ and R¹⁶. In other examples, both R¹ and R¹⁶ may be radicals having formula (III), for which the groups R⁴¹⁻⁴⁸ are the same or different in R¹ and R¹⁶; or both R¹ and R¹⁶ may be radicals having formula (IV), for which the groups R⁵¹⁻⁵⁹ are the same or different in R¹ and R¹⁶.

In some embodiments, at least one of R¹ and R¹⁶ is a radical having formula (II), where R³² and R³⁴ are tert-butyl. In one or more embodiments, R³² and R³⁴ are (C₁-C₁₂)hydrocarbyl or —Si[(C₁-C₁₀)alkyl]₃.

In some embodiments, when at least one of R¹ or R¹⁶ is a radical having formula (III), one of or both of R⁴³ and R⁴⁶ is tert-butyl and R⁴¹⁻⁴², R⁴⁴⁻⁴⁵, and R⁴⁷⁻⁴⁸ are —H. In other embodiments, one of or both of R⁴² and R⁴⁷ is tert-butyl and R⁴¹, R⁴³⁻⁴⁶, and R⁴⁸ are —H. In some embodiments, both R⁴² and R⁴⁷ are —H. In various embodiments, R⁴² and R⁴⁷ are (C₁-C₂₀)hydrocarbyl or —Si[(C₁-C₁₀)alkyl]₃. In other embodiments, R⁴³ and R¹⁶ are (C₁-C₂₀)hydrocarbyl or —Si(C₁-C₁₀)alkyl]₃. In some embodiments, R⁴² and R⁴³ are linked to form a cyclic structure, and R⁴⁶ and R⁴⁷ are linked to form a cyclic structure.

In embodiments, when at least one of R¹ or R¹⁶ is a radical having formula (IV), each R⁵², R⁵³, R⁵⁵, R⁵⁷, and R⁵⁸ are —H, (C₁-C₂₀)hydrocarbyl, —Si[(C₁-C₂₀)hydrocarbyl]₃, or —Ge[(C₁-C₂₀)hydrocarbyl]₃. In some embodiments, at least one of R⁵², R⁵³, R⁵⁵, R⁵⁷, and R⁵⁸ is (C₃-C₁₀)alkyl, —Si[(C₃-C₁₀)alkyl]₃, or —Ge[(C₃-C₁₀)alkyl]₃. In one or more embodiments, at least two of R⁵², R⁵³, R⁵⁵, R⁵⁷, and R⁵⁸ is a (C₃-C₁₀)alkyl, —Si[(C₃-C₁₀)alkyl]₃, or —Ge[(C₃-C₁₀)alkyl]₃. In various embodiments, at least three of R⁵², R⁵³, R⁵⁵, R⁵⁷, and R⁵⁸ is a (C₃-C₁₀)alkyl, —Si[(C₃-C₁₀)alkyl]₃, or —Ge[(C₃-C₁₀)alkyl]₃.

In some embodiments, when at least one of R¹ or R¹⁶ is a radical having formula (IV), at least two of R⁵², R⁵³, R⁵⁵, R⁵⁷, and R⁵⁸ are (C₁-C₂₀)hydrocarbyl or —C(H)₂Si[(C₁-C₂₀)hydrocarbyl]₃.

Examples of (C₃-C₁₀)alkyl include, but are not limited to: propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, n-octyl, tert-octyl (also called 2,4,4-trimethylpentan-2-yl), nonyl, and decyl.

In some embodiment of the metal-ligand catalyst according to formula (I), R¹ and R¹⁶ are chosen from 3,5-di-tert-butylphenyl; 2,4,6-trimethylphenyl; 2,4,6-triisopropylphenyl; 3,5-diisopropylphenyl; carbazolyl; carbazol-9-yl, 1,2,3,4-tetrahydrocarbazolyl; 1,2,3,4,5,6,7,8-octahydrocarbazolyl; 3,6-bis-(3,5-di-tert-butylphenyl) carbazol-9-yl; 3,6-bis-(2,4,6-trimethylphenyl) carbazol-9-yl); 3,6-bis-(2,4,6-triisopropylphenyl) carbazol-9-yl; 2,7-di(tertiarybutyl)-carbazol-9-yl; 2,7-di(tertiary-octyl)-carbazol-9-yl; 2,7-diphenylcarbazol-9-yl; 2,7-bis(2,4,6-trimethylphenyl)-carbazol-9-yl anthracenyl; 1,2,3,4-tetrahydroanthracenyl; 1,2,3,4,5,6,7,8-octahydroanthracenyl; phenanthrenyl; 1,2,3,4,5,6,7,8-octahydrophenanthrenyl; 1,2,3,4-tetrahydronaphthyl; 2,6-dimethylphenyl; 2,6-diisopropylphenyl; 3,5-diphenylphenyl; 1-naphthyl; 2-methyl-1-naphthyl; 2-naphthyl; 1,2,3,4-tetra-hydronaphth-5-yl; 1,2,3,4-tetrahydronaphth-6-yl; anthracen-9-yl; 1,2,3,4-tetrahydroanthracen-9-yl; 1,2,3,4,5,6,7,8-octahydroanthracen-9-yl; 1,2,3,4,5,6,7,8-octahydrophenanthren-9-yl; indolyl; indolinyl; quinolinyl; 1,2,3,4-tetrahydroquinolinyl; isoquinolinyl; or 1,2,3,4-tetrahydroisoquinolinyl.

In formula (I), R², R³, R⁴, R⁵, R⁶, R⁷, R⁸, R⁹, R¹⁰, R¹¹, R¹², R¹³, R¹⁴, and R¹⁵ is independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen.

In one or more embodiments, R², R⁴, R⁵, R¹², R¹³, and R¹⁵ are hydrogen.

In embodiments, the dotted lines are optionally dative bonds between the metal center, M, and the oxygen atom. In some embodiments, one of the dotted lines connecting oxygen atom and M is dative and the other dotted line does not form a dative bond between oxygen atom and M. In various embodiments, both dotted lines form dative bonds between group oxygen atom and M.

In various embodiments, R³ and R¹⁴ are (C₁-C₂₄)alkyl. In one or more embodiments, R³ and R¹⁴ are (C₄-C₂₄)alkyl. In some embodiments, R³ and R¹⁴ are 1-propyl, 2-propyl (also called iso-propyl), 1,1-dimethylethyl (also called tert-butyl), cyclopentyl, cyclohexyl, 1-butyl, pentyl, 3-methyl-1-butyl, hexyl, 4-methyl-1-pentyl, heptyl, n-octyl, tert-octyl (also called 2,4,4-trimethylpentan-2-yl), nonyl, and decyl. In embodiments, R³ and R¹⁴ are —OR^{C}, wherein R^{C} is (C₁-C₂₀)hydrocarbon, and in some embodiments, R^{C} is methyl, ethyl, 1-propyl, 2-propyl (also called iso-propyl), or 1,1-dimethylethyl.

In one or more embodiments, one of R⁸ and R¹⁴ is not —H. In various embodiments, at least one of R⁸ and R⁹ is (C₁-C₂₄)alkyl. In some embodiments, both R⁸ and R⁹ are (C₁-C₂₄)alkyl. In some embodiments, R⁸ and R⁹ are methyl. In other embodiments, R⁸ and R⁹ are halogen.

In some embodiments, R³ and R¹⁴ are methyl; In one or more embodiments, R³ and R¹⁴ are (C₄-C₂₄)alkyl. In some embodiments, R⁸ and R⁹ are 1-propyl, 2-propyl (also called iso-propyl), 1,1-dimethylethyl (also called tert-butyl), cyclopentyl, cyclohexyl, 1-butyl, pentyl, 3-methyl-(-butyl, hexyl, 4-methyl-1-pentyl, heptyl, n-octyl, tert-octyl (also called 2,4,4-trimethylpentan-2-yl), nonyl, and decyl.

In various embodiments, in the metal-ligand complex of formula (I), R⁶ and R¹¹ are halogen. In some embodiments, R⁶ and R¹¹ are (C₁-C₂₄)alkyl. In various embodiments, R⁶ and R¹¹ independently are chosen from methyl, ethyl, 1-propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, n-octyl, tert-octyl (also called 2,4,4-trimethylpentan-2-yl), nonyl, and decyl. In some embodiments, R⁶ and R¹¹ are tert-butyl. In embodiments, R⁶ and R¹¹ are —OR^{C}, wherein R^{C} is (C₁-C₂₀)hydrocarbyl, and in some embodiments, R^{C} is methyl, ethyl, 1-propyl, 2-propyl (also called iso-propyl), or 1,1-dimethylethyl. In other embodiments, R⁶ and R¹¹ are —SiR^{C}₃, wherein each R^{C} is independently (C₁-C₂₀)hydrocarbyl, and in some embodiments, R^{C} is methyl, ethyl, 1-propyl, 2-propyl (also called iso-propyl), or 1,1-dimethylethyl.

In some embodiments, any or all of the chemical groups (e.g., R¹⁻⁵⁹) of the metal-ligand complex of formula (I) may be unsubstituted. In other embodiments, none, any, or all of the chemical groups R¹⁻⁵⁹ of the metal-ligand complex of formula (I) may be substituted with one or more than one R^{S}. When two or more than two R^{S} are bonded to a same chemical group of the metal-ligand complex of formula (I), the individual R^{S} of the chemical group may be bonded to the same carbon atom or heteroatom or to different carbon atoms or heteroatoms. In some embodiments, none, any, or all of the chemical groups R¹⁻⁵⁹ may be persubstituted with R^{S}. In the chemical groups that are persubstituted with R^{S}, the individual R^{S} may all be the same or may be independently chosen. In one or more embodiments, R^{S} is chosen from (C₁-C₂₀)hydrocarbyl, (C₁-C₂₀)alkyl, (C₁-C₂₀)heterohydrocarbyl, or (C₁-C₂₀)heteroalkyl.

In formula (I), L is (C₁-C₄₀)hydrocarbylene or (C₁-C₄₀)heterohydrocarbylene; and each Z is independently chosen from —O—, —S—, —N(R^{N})—, or —P(R^{P})—. In one or more embodiments, L includes from 1 to 10 atoms.

In formulas (I), (II), (III), and (IV), each R^{C}, R^{P}, and R^{N} is independently a (C₁-C₃₀)hydrocarbyl, (C₁-C₃₀)heterohydrocarbyl, or —H.

In some embodiments of formula (I), the L may be chosen from (C₃-C₇)alkyl 1,3-diradicals, such as —CH₂CH₂CH₂—, —CH(CH₃)CH₂C*H (CH₃), —CH(CH₃)CH(CH₃) C*H (CH₃), —CH₂C(CH₃)₂CH₂—, cyclopentan-1,3-diyl, or cyclohexan-1,3-diyl, for example. In some embodiments, the L may be chosen from (C₄-C₁₀)alkyl 1,4-diradicals, such as CH₂CH₂CH₂CH₂—, —CH₂C(CH₃)₂C(CH₃)₂CH₂—, cyclohexane-1,2-diyldimethyl, and bicyclo[2.2.2]octane-2,3-diyldimethyl, for example. In some embodiments, L may be chosen from (C₅-C₁₂)alkyl 1,5-diradicals, such as —CH₂CH₂CH₂CH₂CH₂—, and 1,3-bis(methylene)cyclohexane. In some embodiments, L may be chosen from (C₆-C₁₄)alkyl 1,6-diradicals, such as —CH₂CH₂CH₂CH₂CH₂CH₂— or 1,2-bis(ethylene)cyclohexane, for example.

In one or more embodiments, L is (C₂-C₄₀)heterohydrocarbylene, and at least one of the from 2 to 10 atoms includes a heteroatom. In some embodiments, L is-CH₂Ge(R^{C})₂CH₂—, where each R^{C} is (C₁-C₃₀)hydrocarbyl. In some embodiments, L is-CH₂Ge(CH₃)₂CH₂—, CH₂Ge(ethyl)₂CH₂—, —CH₂Ge(2-propyl)₂CH₂—, —CH₂Ge(1-butyl)₂CH₂—, —CH₂Ge(cyclopentyl)₂CH₂—, or —CH₂Ge(cyclohexyl)₂CH₂—.

In one or more embodiments, L is chosen from —CH₂—; —CH₂CH₂—; —CH₂ (CH₂)ₘCH₂—, where m is from 1 to 3; —CH₂Si(R^{C})₂CH₂—; —CH₂Ge(R^{C})₂CH₂—; —CH(CH₃)CH₂CH*(CH₃); and CH₂ (phen-1,2-di-yl)CH₂—; where each R^{C} in L is (C₁-C₂₀)hydrocarbyl.

Examples of such (C₁-C₁₂)alkyl include, but are not limited to methyl, ethyl, 1-propyl, 2-propyl (also called iso-propyl), 1,1-dimethylethyl, cyclopentyl, or cyclohexyl, butyl, tert-butyl, pentyl, hexyl, heptyl, n-octyl, tert-octyl (also called 2,4,4-trimethylpent-2-yl), nonyl, decyl, undecyl, and dodecyl.

In some embodiments, in the metal-ligand complex according to formula (I), both R⁸ and R⁹ are methyl. In other embodiments, one of R⁸ and R⁹ is methyl and the other of R⁸ and R⁹ is —H.

In the metal-ligand complex according to formula (I), X bonds with M through a covalent bond or an ionic bond. In some embodiments, X is fluorine, chlorine, bromine or iodine atom.

In one or more embodiments, M is scandium, yttrium, a lanthanide metal. The lanthanide metal may be lanthanum, cerium, praseodymium, neodymium, promethium, samarium, europeium, gadolinium, terbium, dysprosium, holmium erbium, thulium, ytterbium, or lutetium.

In the metal-ligand complex according to formula (I), each T bonds with M through a a dative bond or an ionic bond. In one or more embodiments, T is a Lewis base. The Lewis base may be a compound or an ionic species, which can donate an electron pair to an acceptor compound. For purposes of this description, the acceptor compound is M, the metal of the metal-ligand complex of formula (I). The Lewis base may be neutral or anionic. In some embodiments, the Lewis base may be a heterohydrocarbon or a hydrocarbon. Examples of neutral heterohydrocarbon lewis bases includes, but are not limited to, amines, trialkylamines, ethers, cycloethers, or sulfides. An example of anionic hydrocarbon includes, but is not limited to, cyclopentadiene. An example of a neutral hydrocarbon includes, but is not limited to, 1,3-buta-di-ene.

In one or more embodiments, the Lewis base may be a monodentate ligand that may a neutral ligand. In some embodiments, the neutral ligand may contain a heteroatom. In specific embodiments, the neutral ligand is a neutral group such as R^{T}NR^{K}R^{L}, R^{K}OR^{L}, R^{K}SR^{L}, or R^{T}PR^{K}R^{L}, where each R^{T} independently is hydrogen, [(C₁-C₁₀)hydrocarbyl]₃Si(C₁-C₁₀)hydrocarbyl, (C₁-C₄₀)hydrocarbyl, [(C₁-C₁₀)hydrocarbyl]₃Si, or (C₁-C₄₀)heterohydrocarbyl and each R^{K} and R^{L} independently is as previously defined.

In some embodiments, the Lewis base is (C₁-C₂₀)hydrocarbon. In some embodiments, the Lewis base is cyclopentadiene or 1,3-buta-di-ene.

In various embodiments, the Lewis base is (C₁-C₂₀)heterohydrocarbon, wherein the hetero atom of the heterohydrocarbon is oxygen. In some embodiments, T is tetrahydrofuran, diethyl ether, or methyl tert-butyl ether (MTBE).

In specific embodiments of catalyst systems, the metal-ligand complex according to formula (I) may include, without limitation, a complex having the structure of any of Inventive Metal-Ligand Complexes 1-12:

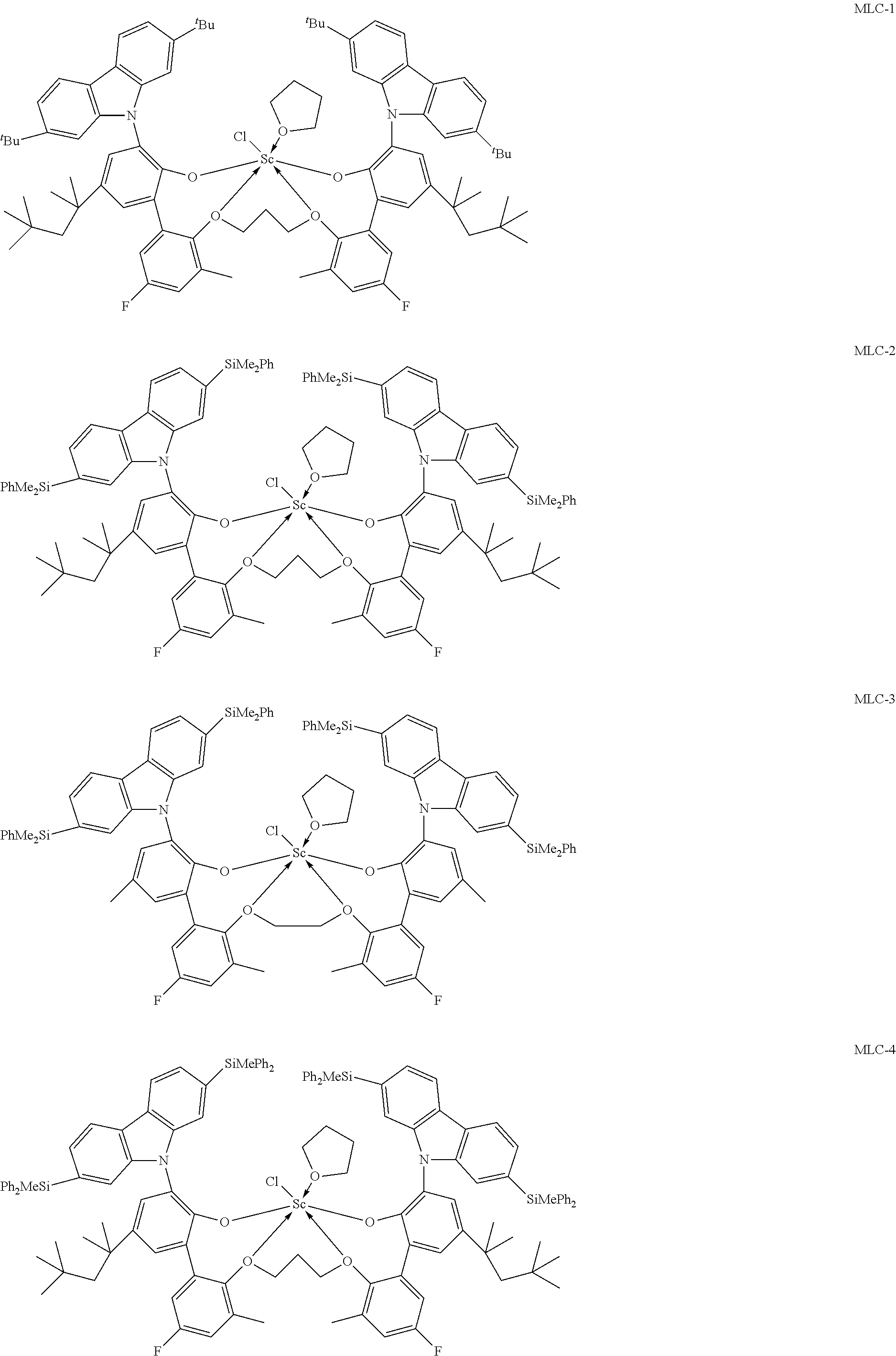

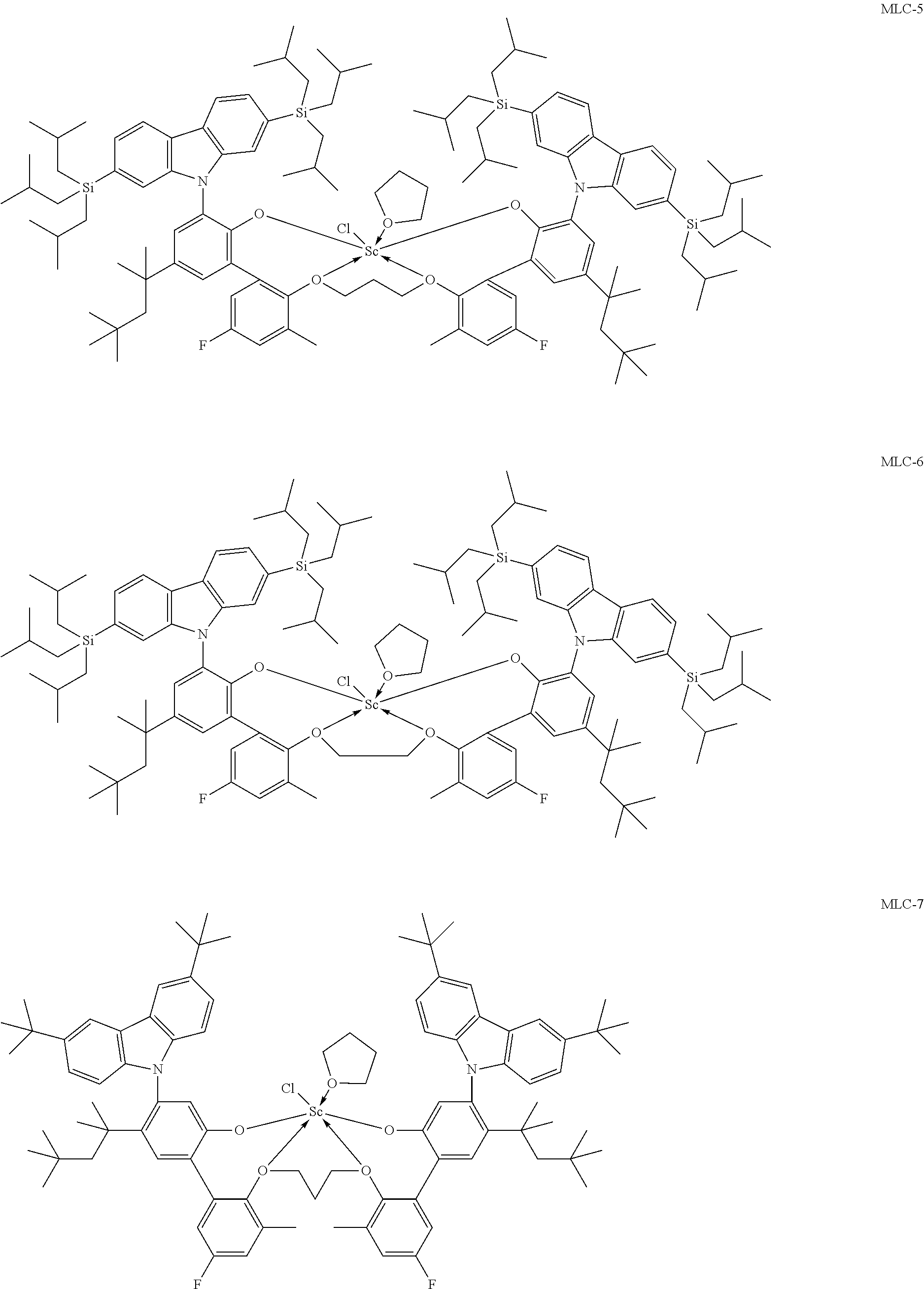

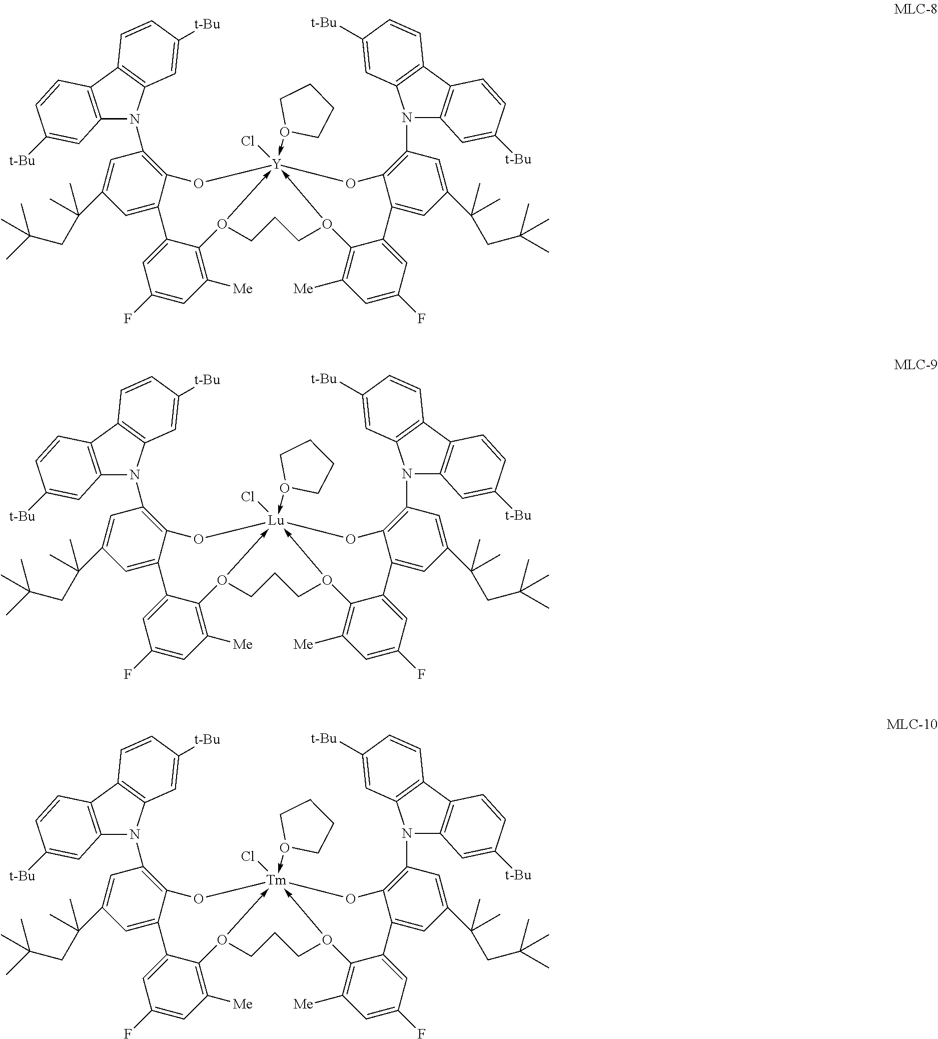

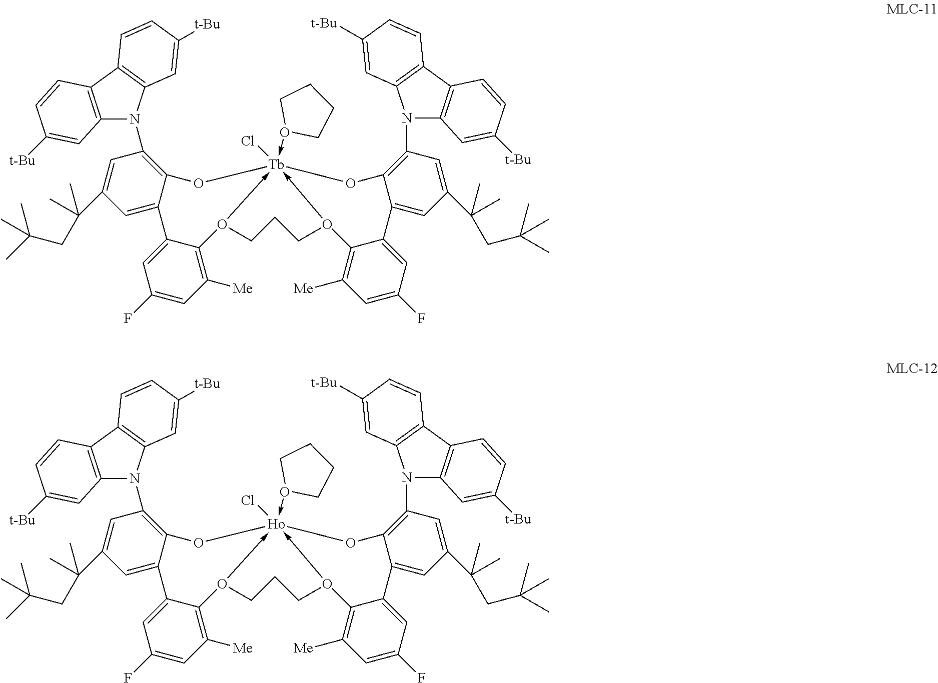

### Olefin Propagation

The metal-ligand complexes of this disclosure cannot initiate olefin propagation when the ligand X is a halogen atom. It is believed that the halogen atom, X, transfers to the co-catalyst and an alkyl group of the co-catalyst transfers to the metal center, M. Once there is an alkyl group ligand, propagation (i.e. polymerization) may begin. Additionally and without intent to be bound by theory, it is believed that the metal-ligand catalyst is not efficient when the Lewis base, T, is coordinated to the metal center, M, of formula (I). Therefore, it is believed that during olefin propagation, the Lewis base disassociates from the metal center, M, and the metal-ligand complex has a structure according to formula (Ia):

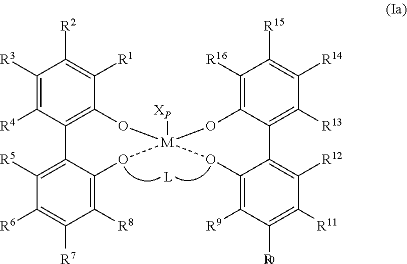

In formula (Ia), R¹ through R¹⁶, M, and L are as defined in formula (I). X_{P} is hydrocarbyl, where the hydrocarbyl is branched or unbranched having at least 30 carbon atoms. More specifically, X_{P} is the propagating olefin chain.

### Additive Component

In some embodiments, the catalyst system comprises one or more additives. In some embodiments, the additives function as a co-catalyst, an alkylating agent, Lewis Acid or Lewis Base. In other embodiments, the additives function as a scavenger or scavenging agent. A co-catalyst is a reagent that reacts in cooperation with a catalyst to catalyze the reaction or improve the catalytic activity of the catalyst. Without intent to be bound by theory, it is believed the Lewis Base, T, of formula (I), dissociates without the presence of a co-catalyst. However, it is also believed that a co-catalyst may promote the dissociation of the Lewis base from the metal center of the metal-ligand complex.

A scavenging agent sequesters impurities in the reactor prior to addition of the precatalyst, and as such, does not constitute an activator. Lower loading of alumoxanes do not act as co-catalysts, rather they serve as scavenging agent.

Without intent to be bound by theory, it is believed that the metal-ligand complex of formula (I) is not an active species unless an alkylating agent exchanges an alkyl group for the halogen (specifically X) coordinated to the metal center M. Upon alkylating the metal-ligand complex of formula (I), and dissociation of the Lewis Base, the complex is active and can polymerize olefin monomers.

In one or more embodiments, the alkylating agent may be chosen from methyl modified aluminoxane (MMAO) or alkyl aluminum compounds.

In some embodiments, the additives may include, but are not limited to, alkyl aluminums; polymeric or oligomeric alumoxanes (also known as aluminoxanes); Lewis acids, and non-polymeric, non-coordinating, ion-forming compounds (including the use of such compounds under oxidizing conditions). Combinations of one or more of the foregoing additives and techniques are also contemplated. The term “alkyl aluminum” means a monoalkyl aluminum dihydride or monoalkylaluminum dibalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

In some embodiments, the additive is a Lewis acid Group 13 metal compounds containing (C₁-C₂₀)hydrocarbyl substituents as described herein. In some embodiments, the additives include tri((C₁-C₂₀)hydrocarbyl)-substituted-aluminum or tri((C₁-C₂₀)hydrocarbyl)-boron compounds. In other embodiments, the additives are chosen from tri(hydrocarbyl)-substituted-aluminum, tri((C₁-C₂₀)hydrocarbyl)-boron compounds, tri((C₁-C₁₀)alkyl)aluminum, tri((C₆-C₁₈)aryl) boron compounds, and halogenated (including perhalogenated) derivatives thereof.

In one or more embodiments, the polymerization process further includes a borane or borate-based additive. In some embodiments, the borane-based additive is selected from tris(fluoro-substituted phenyl)boranes, tris(pentafluorophenyl)borane. In some embodiments, the co-catalyst is a tris((C₁-C₂₀)hydrocarbyl)ammonium tetra((C₁-C₂₀)hydrocarbyl)borate (e.g. bis(octadecyl)methylammonium tetrakis(pentafluorophenyl)borate). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₆)hydrocarbyl, when two or more are present, may be the same or different.

In one or more embodiments, the additive may be chosen from polymeric or oligomeric aluminoxanes, especially methyl aluminoxane, as well as inert, compatible, noncoordinating, ion forming compounds. Exemplary suitable additives include, but are not limited to modified methyl aluminoxane (MMAO), bis(hydrogenated tallow alkyl)methyl, tetrakis(pentafluorophenyl)borate(l-)ammonium, triethyl aluminum, butylatedhydroxy-toluene diethyl aluminum, bis-(butylatedhydroxy-toluene) ethyl aluminum, tris-(butylatedhydroxy-toluene) aluminum and combinations thereof.

In some embodiments, the aluminum alkyl species is triisobutylaluminum (TiBAl) or aluminoxanes. The alkylaluminoxane may be a polymeric form of a (C₁-C₁₀)alkylaluminoxane or a polymethylaluminoxane (PMAO). The PMAO may be a polymethylaluminoxane-Improved Performance (PMAO-IP), which is commercially available from AkzoNobel. The (C₁-C₁₀)alkylaluminoxane may be methylaluminoxane (MAO), a modified methylaluminoxane (MMAO) such as modified methylaluminoxane, type 3A (MMAO-3A), type 7 (MMAO-7), or type 12 (MMAO-12), ethylaluminoxane, n-propylaluminoxane, isopropylaluminoxane, butylaluminoxane, isobutylaluminoxane, n-pentylaluminoxane, neopentylaluminoxane, n-hexylaluminoxane, n-octylaluminoxane, 2-ethylhexylaluminoxane, cyclohexylaluminoxane, or 1-methylcyclopentylaluminoxane. The arylaluminoxane may be a (C₆-C₁₀)arylaluminoxane, which may be phenylaluminoxane, 2,6-dimethylphenylaluminoxane, or naphthylaluminoxane.

In some embodiments, one or more co-catalysts may be used in combination with each other. A specific example of a co-catalyst combination is a mixture of a tri((C₁-C₅)hydrocarbyl)aluminum, tri((C₁-C₄)hydrocarbyl)borane, tri((C₆-C₁₈)aryl)borane or an ammonium borate with an oligomeric or polymeric alumoxane compound. The ratio of total number of moles of one or more metal-ligand complexes of formula (I) to total number of moles of one or more of the co-catalysts is from 1:10,000 to 100.1. In some embodiments, the ratio is at least 1:5000, in some other embodiments, at least 1:1000; and 10:1 or less, and in some other embodiments, 1:1 or less. When an alumoxane alone is used as the co-catalyst, preferably the ratio Al of the alumoxane and metal of the metal ligand complex of formula (I) (Al/M) is at least 20. When tris(pentafluorophenyl)borane alone is used as the co-catalyst, in some other embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1.

### Catalyst System Components

The catalyst system includes a procatalyst. The procatalyst may be chosen from a Group IV metal-ligand complex such as a titanium (Ti) metal-ligand complex, a zirconium (Zr) metal-ligand complex, or a hafnium (Hf) metal-ligand complex. In one or more embodiments, the Group IV metal-ligand complex includes a bis-biphenylphenoxy Group IV metal-ligand complex, a procatalyst, which may be rendered catalytically active upon contact with the activators of this disclosure.

According to some embodiments, the bis-biphenylphenoxy Group IV metal-ligand complex has a structure according to formula (X):

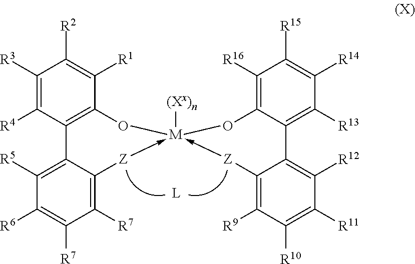

In formula (X), M is a metal chosen from titanium, zirconium, or hafnium, the metal being in a formal oxidation state of +2, +3, or +4. Subscript n of (X) n is 0, 1, or 2. When subscript n is 1, X^{X} is a monodentate ligand or a bidentate ligand, and when subscript n is 2, each X^{X} is a monodentate ligand. In formula (X), each Z is independently chosen from —O—, —S—, —N(R^{N})—, or —P(R^{P})—; R²⁻⁴, R⁵⁻⁸, R⁹⁻¹² and R¹³⁻¹⁵ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, and halogen. R¹ and R¹⁶ are selected from radicals having formula (XI), radicals having formula (XII), and radicals having formula (XIII):

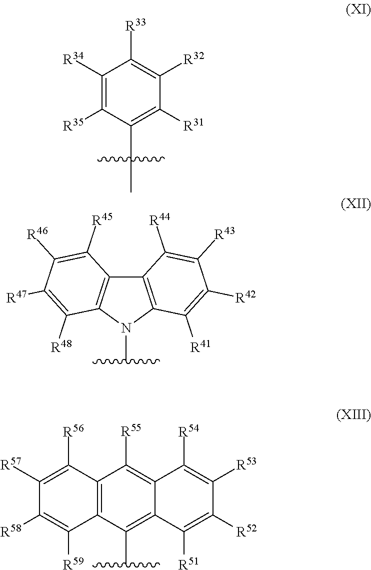

In formulas (XI), (XII), and (XIII), each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

In one or more embodiments, in formula (X), each X^{X} can be a monodentate ligand that, independently from any other ligands X^{X}, is a halogen, unsubstituted (C₁-C₂₀)hydrocarbyl, unsubstituted [(C₁-C₂₀)hydrocarbyl]C(O)O—, or R^{K}R^{L}N—, wherein each of R^{K} and R^{L} independently is an unsubstituted (C₁-C₂₀)hydrocarbyl, (C₁-C₂₀)heterohydrocarbyl. In some embodiments, X^{X} is phenyl, benzyl, chlorine atom, (C₁-C₁₀)alkyl, or —CH₂Si(R^{XV})₃, where R^{XV} is (C₁-C₂₀)alkyl.

Other bis-biphenylphenoxy Group IV metal-ligand complexes that may be used in combination with the bimetallic activators in the catalyst systems of this disclosure will be apparent to those skilled in the art.

In one or more embodiments, the Group IV metal-ligand complex includes a constrained-geometry Group IV complex having a structure according to formula (XV):

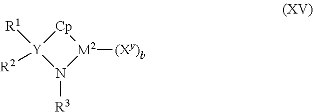

In formula (XV), M² is titanium, hafnium or zirconium. Subscript b of (X^{y})_{b} is 1, 2, or 3. Each X is a monodentate ligand or bidentate ligand independently chosen from unsaturated (C₂-C₅₀)hydrocarbon, unsaturated (C₂-C₅₀)heterohydrocarbon, saturated (C₂-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, —N(R^{N})₂, and —NCOR^{C}. The metal-ligand complex is overall charge-neutral.

In one or more embodiments, each X^{y} can be a monodentate ligand that, independently from any other ligands X^{y}, is a halogen, unsubstituted (C₁-C₂₀)hydrocarbyl, unsubstituted [(C₁-C₂₀)hydrocarbyl]C(O)O—, or R^{K}R^{L}N—, wherein each of R^{K} and R^{L} independently is an unsubstituted (C₁-C₂₀)hydrocarbyl, (C₁-C₂₀)heterohydrocarbyl. In some embodiments, X^{y} is phenyl, benzyl, chlorine atom, (C₁-C₁₀)alkyl, or —CH₂Si(R^{XV})₃, where R^{XV} is (C₁-C₂₀)alkyl.

In formula (XV), Cp is selected from the group consisting of cyclopentadienyl and R^{S} substituted cyclopentadienyl, the Cp being bound in an η⁵ bonding mode to M, wherein R^{S} is independently selected from the group consisting of (C₁-C₂₀)alkyl, (C₁-C₂₀)heteroalkyl, (C₁-C₂₀)aryl, or R^{S} substituent (C₁-C₂₀)aryl, (C₁-C₂₀)heteroaryl, or R^{S} substituent (C₁-C₂₀)heteroaryl, wherein two adjacent R^{S} groups are optionally linked to form a ring.

In formula (XV), N is nitrogen; Y is carbon or silicon; wherein Y is covalently bonded to Cp; and R¹ and R² are independently selected from —H, (C₁-C₄₀)hydrocarbyl, and (C₁-C₄₀)heterohydrocarbyl; and R³ are independently selected from (C₁-C₄₀)hydrocarbyl, and (C₁-C₄₀)heterohydrocarbyl.

Other catalysts, especially catalysts containing one or more other Group IV metal-complexes not specifically listed above, will be apparent to those skilled in the art.

### Catalyst System Properties

The procatalyst comprising the metal-ligand complex of formula (I) and one or more cocatalyst, as described herein, has a reactivity ratio r1, as further defined hereinbelow, in the range of greater than 100; for example, greater than 150, greater than 200, greater than 300, or greater than 500.

For random copolymers in which the identity of the last monomer inserted dictates the rate at which subsequent monomers insert, the terminal copolymerization model is employed. In this model insertion reactions of the type

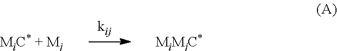

where C* represents the catalyst, Mᵢ represents monomer i, and kᵢⱼ is the rate constant having the rate equation

$${R}_{{p}_{ij}} = {k}_{ij} [ … {M}_{i} {C}^{*} ] [ {M}_{j} ] \qquad ( B )$$

The comonomer mole fraction (i=2) in the reaction media is defined by the equation:

$${f}_{2} = \frac{[ {M}_{2} ]}{[ {M}_{1} ] + [ {M}_{2} ]} \qquad ( C )$$

A simplified equation for comonomer composition can be derived as disclosed in George Odian, Principles of Polymerization, Second Edition, John Wiley and Sons, 1970, as follows:

$${F}_{2} = \frac{{{r}_{1} ( 1 - {f}_{2} )}^{2} + ( 1 - {f}_{2} ) {f}_{2}}{{{r}_{1} ( 1 - {f}_{2} )}^{2} + 2 ( 1 - {f}_{2 )} ) {f}_{2} + {r}_{2} {f}_{2}^{2}} \qquad ( D )$$

From this equation the mole fraction of comonomer in the polymer is solely dependent on the mole fraction of comonomer in the reaction media and two temperature dependent reactivity ratios defined in terms of the insertion rate constants as:

$${r}_{1} = \frac{{k}_{11}}{{k}_{12}} {r}_{2} = \frac{{k}_{22}}{{k}_{21}} \qquad ( E )$$

Alternatively, in the penultimate copolymerization model, the identities of the last two monomers inserted in the growing polymer chain dictate the rate of subsequent monomer insertion. The polymerization reactions are of the form

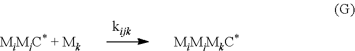

and the individual rate equations are:

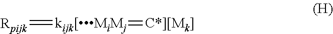

The comonomer content can be calculated (again as disclosed in George Odian, Supra.) as:

$$\frac{( 1 - {F}_{2} )}{{F}_{2}} = \frac{1 + \frac{{r}_{1}^{′} X ( {r}_{1} X + 1 )}{( {r}_{1}^{′} X + 1 )}}{1 + \frac{{r}_{2}^{′} ( {r}_{2} + X )}{X ( {r}_{2}^{′} + X )}} \qquad ( I )$$

where X is defined as:

$$X = \frac{( 1 - {f}_{2} )}{{f}_{2}} \qquad ( J )$$

and the reactivity ratios are defined as:

$${r}_{1} = \frac{{k}_{111}}{{k}_{112}} {r}_{1}^{′} = \frac{{k}_{211}}{{k}_{212}} \qquad ( K )$$

$${r}_{2} = \frac{{k}_{222}}{{k}_{221}} {r}_{2}^{′} = \frac{{k}_{122}}{{k}_{121}}$$

For this model as well the polymer composition is a function only of temperature dependent reactivity ratios and comonomer mole fraction in the reactor. The same is also true when reverse comonomer or monomer insertion may occur or in the case of the interpolymerization of more than two monomers.

Reactivity ratios for use in the foregoing models may be predicted using well known theoretical techniques or empirically derived from actual polymerization data. Suitable theoretical techniques are disclosed, for example, in B. G. Kyle, Chemical and Process Thermodynamics, Third Addition, Prentice-Hall, 1999 and in Redlich-Kwong-Soave (RKS) Equation of State, Chemical Engineering Science, 1972, pp 1197-1203. Commercially available software programs may be used to assist in deriving reactivity ratios from experimentally derived data. One example of such software is Aspen Plus from Aspen Technology, Inc., Ten Canal Park, Cambridge, MA 02141-2201 USA.

Accordingly, the process for producing ethylene based polymers according to the present invention selectively gives the rich polyethylene (e.g., a high density polyethylene) or rich polyethylene segment of the poly(ethylene alpha-olefin) copolymer in the presence of alpha-olefin, which is substantially unpolymerized thereby. The process for producing ethylene-based polymers employs olefin polymerizing conditions. In some embodiments, the olefin polymerizing conditions independently produce a catalyst in situ that is formed by reaction of the procatalyst comprising metal-ligand complex of formula (I), and one or more cocatalysts in the presence of one or more other ingredients. Such other ingredients include, but are not limited to, (i) olefin monomers; (ii) another metal-ligand complex of formula (I); (iii) one or more of catalyst systems; (iv) one or more chain shuttling agents; (v) one or more catalyst stabilizers; (vi) one or more solvents; and (vii) a mixture of any two or more thereof.

A particularly inventive catalyst is one that can achieve a high selectivity for polymerizing ethylene in the presence of the (C₃-C₄₀) alpha-olefin in the process for producing an ethylene-based polymer, wherein the high selectivity is characterized by the reactivity ratio r1 described previously. Preferably for the inventive process, the reactivity ratio r1 is greater than 50, more preferably greater than 100, still more preferably greater than 150, still more preferably greater than 200. When the reactivity ratio r1 for the invention process approaches infinity, incorporation of the alpha-olefin into (or onto) the rich polyethylene produced thereby approaches 0 mole percent (mol %).

The inventive catalyst composition comprising the procatalyst and one or more cocatalyst, as described herein, has catalytic efficiency in the rage of from greater than 1000,000 g of polymer per gram of active metal center; for example, from greater than 2000,000 g of polymer per gram of active metal center. The catalytic efficiency is measured in terms of amount of polymer produced relative to the amount catalyst used in solution polymerization process, wherein the polymerzation temperature is at least 130° C., for example in the range of from 170 to 195° C., and ethylene concentration is greater than 5 g/L, for example, greater than 6 g/L, and wherein the ethylene conversion is greater than 70 percent, for example, greater than 80 percent, or in the alternative, greater than 90 percent.

### Polyolefins

The catalytic systems described in this disclosure may be utilized in the polymerization of olefins, primarily ethylene, propylene, α-olefins, such as octene, and dienes. In some embodiments, there is only a single type of olefin or α-olefin in the polymerization scheme, creating a homopolymer. However, additional α-olefins may be incorporated into the polymerization procedure. The additional α-olefin co-monomers typically have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of propylene, 1-butene, 1hexene, and 1-octene; or in the alternative, from the group consisting of 1-hexene and loctene.

The ethylene-based polymers, for example homopolymers and/or interpolymers (including copolymers) of ethylene and optionally one or more co-monomers such as α-olefins, may comprise from at least 50 mole percent (mol %) monomer units derived from ethylene. All individual values and subranges encompassed by “from at least 50 mole percent” are disclosed herein as separate embodiments; for example, the ethylene based polymers, homopolymers and/or interpolymers (including copolymers) of ethylene and optionally one or more co-monomers such as α-olefins may comprise at least 60 mole percent monomer units derived from ethylene; at least 70 mole percent monomer units derived from ethylene; at least 80 mole percent monomer units derived from ethylene; or from 50 to 100 mole percent monomer units derived from ethylene; or from 80 to 100 mole percent monomer units derived from ethylene.

In some embodiments, the catalyst systems may produce ethylene-based polymers that include at least 90 mole percent units derived from ethylene. All individual values and subranges from at least 90 mole percent are included herein and disclosed herein as separate embodiments. For example, the ethylene-based polymers may comprise at least 93 mole percent units derived from ethylene; at least 96 mole percent units; at least 97 mole percent units derived from ethylene; or in the alternative, from 90 to 100 mole percent units derived from ethylene; from 90 to 99.5 mole percent units derived from ethylene; or from 97 to 99.5 mole percent units derived from ethylene.

In some embodiments, the catalyst system produces ethylene-based polymers having an amount of additional α-olefin that is less than 50 mole percent (mol %); other embodiments the amount of additional α-olefin includes at least 0.01 mol % to 25 mol %; and in further embodiments the amount of additional α-olefin includes at least 0.1 mol % to 10 mol %. In some embodiments, the additional α-olefin is 1-octene.

The ethylene-based polymers may be produced by otherwise conventional polymerization processes that incorporate the catalyst systems according to embodiments of this disclosure. Such conventional polymerization processes include, but are not limited to, solution polymerization processes, gas phase polymerization processes, slurry phase polymerization processes, and combinations thereof using one or more conventional reactors such as loop reactors, isothermal reactors, fluidized bed gas phase reactors, stirred tank reactors, batch reactors in parallel, series, or any combinations thereof, for example.

In one embodiment, the ethylene-based polymer may be produced via solution polymerization in a dual reactor system, for example a dual loop reactor system, wherein ethylene and, optionally, one or more α-olefins are polymerized in the presence of the catalyst system, as described herein, and optionally one or more co-catalysts. In another embodiment, the ethylene-based polymer may be produced via solution polymerization in a dual reactor system, for example a dual loop reactor system, wherein ethylene and optionally one or more α-olefins are polymerized in the presence of the catalyst system in this disclosure, and as described herein, and optionally one or more other catalysts. The catalyst systems, as described herein, can be used in the first reactor, or second reactor, optionally in combination with one or more other catalysts. In one embodiment, the ethylene-based polymer may be produced via solution polymerization in a dual reactor system, for example a dual loop reactor system, wherein ethylene and optionally one or more α-olefins are polymerized in the presence of the catalyst system, as described herein, in both reactors.

In another embodiment, the ethylene-based polymer may be produced via solution polymerization in a single reactor system, for example a single loop reactor system, in which ethylene and optionally one or more α-olefins are polymerized in the presence of the catalyst system, as described within this disclosure, and optionally one or more cocatalysts, as described in the preceding paragraphs.

The ethylene-based polymers may further comprise one or more additives. Such additives include, but are not limited to, antistatic agents, color enhancers, dyes, lubricants, pigments, primary antioxidants, secondary antioxidants, processing aids, UV stabilizers, and combinations thereof. The ethylene-based polymers may contain any amounts of additives. The ethylene-based polymers may compromise from about 0 to about 10 percent by the combined weight of such additives, based on the weight of the ethylene-based polymers and the one or more additives. The ethylene-based polymers may further comprise fillers, which may include, but are not limited to, organic or inorganic fillers. The ethylene-based polymers may contain from about 0 to about 20 weight percent fillers such as, for example, calcium carbonate, talc, or Mg(OH)₂, based on the combined weight of the ethylene-based polymers and all additives or fillers. The ethylene-based polymers may further be blended with one or more polymers to form a blend.

In some embodiments, a polymerization process for producing an ethylene-based polymer may include polymerizing ethylene and at least one additional α-olefin in the presence of a catalyst system, wherein the catalyst system incorporates at least one metal-ligand complex of formula (I). The polymer resulting from such a catalyst system that incorporates the metal-ligand complex of formula (I) may have a density according to ASTM D792 (incorporated herein by reference in its entirety) from 0.850 g/cm³ to 0.970 g/cm³, from 0.870 g/cm³ to 0.950 g/cm³, from 0.870 g/cm³ to 0.920 g/cm³, or from 0.870 g/cm³ to 0.900 g/cm³, for example.

In embodiments, the polymer resulting from the catalyst system that includes the metal-ligand complex of formula (I) has a melt flow ratio (I₁₀/I₂) from 5 to 15, in which melt index I₂ is measured according to ASTM D1238 (incorporated herein by reference in its entirety) at 190° C. and 2.16 kg load, and melt index I₁₀ is measured according to ASTM D1238 at 190° C. and 10 kg load. In other embodiments the melt flow ratio (I_{10/12}) is from 5 to 10, and in others, the melt flow ratio is from 5 to 9.

In some embodiments, the polymer resulting from the catalyst system that includes the metal-ligand complex of formula (I) has a melt index (12) from 0.1 to 100, in which melt index I₂ is measured according to ASTM D1238 (incorporated herein by reference in its entirety) at 190° C. and 2.16 kg load.

In some embodiments, the polymer resulting from the catalyst system that includes the metal-ligand complex of formula (I) has a molecular-weight distribution (MWD) from 1.0 to 25, where MWD is defined as Mw/Mn with Mw being a weight-average molecular weight and Mn being a number-average molecular weight. In other embodiments, the polymers resulting from the catalyst system have a MWD from 1.5 to 6. Another embodiment includes a MWD from 1.5 to 3; and other embodiments include MWD from 2 to 2.5.

### SymRAD HT-GPC Analysis

The molecular weight data is determined by analysis on a hybrid Robot-Assisted Dilution High-Temperature Gel Permeation Chromatographer (Sym-RAD-GPC) built by Symyx/Dow. The polymer samples are dissolved by heating for 120 minutes at 160° C. in 1,2,4-trichlorobenzene (TCB) at a concentration of 10 mg/mL stabilized by 300 parts per million (ppm) of butylated hydroxyl toluene (BHT). Each sample was diluted to 1 mg/mL immediately before the injection of a 250 μL aliquot of the sample. The GPC is equipped with two Polymer Labs PLgel 10 μm MIXED-B columns (300×10 mm) at a flow rate of 2.0 mL/minute at 160° C. Sample detection is performed using a PolyChar IR4 detector in concentration mode. A conventional calibration of narrow polystyrene (PS) standards is utilized with apparent units adjusted to homo-polyethylene (PE) using known Mark-Houwink coefficients for PS and PE in TCB at this temperature.

### 1-Octene Incorporation IR Analysis

The running of samples for the HT-GPC analysis precedes the IR analysis. For the IR analysis, a 48-well HT silicon wafer is utilized for deposition and analysis of 1-octene incorporation of samples. For the analysis, the samples are heated to 160° C. for less than or equal to 210 minutes; the samples are reheated to remove magnetic GPC stir bars and are shaken with glass-rod stir bars on a J-KEM Scientific heated robotic shaker. Samples are deposited while being heated using a Tecan MiniPrep 75 deposition station, and the 1,2,4-trichlorobenzene is evaporated off the deposited wells of the wafer at 160° C. under nitrogen purge. The analysis of 1-octene is performed on the HT silicon wafer using a NEXUS 670 E.S.P. FT-IR.

### Differential Scanning Calorimetry (DSC)

Differential Scanning calorimetry (DSC) is used to measure Tm, Tc, Tg and crystallinity in ethylene-based (PE) samples and propylene-based (PP) samples. Each sample (0.5 g) was compression molded into a film, at 5000 psi, 190° C., for two minutes. About 5 to 8 mg of film sample was weighed and placed in a DSC pan. The lid was crimped on the pan to ensure a closed atmosphere. The sample pan was placed in a DSC cell, and then heated, at a rate of approximately 10° C./min, to a temperature of 180° C. for PE (230° C. for PP). The sample was kept at this temperature for three minutes. Then the sample was cooled at a rate of 10° C./min to −90° C. for PE (−60° C. for PP), and kept isothermally at that temperature for three minutes. The sample was next heated at a rate of 10° C./min, until complete melting (second heat). Unless otherwise stated, melting point (Tm) and the glass transition temperature (Tg) of each polymer were determined from the second heat curve, and the crystallization temperature (Tc) was determined from the first cooling curve. The respective peak temperatures for the Tm and the Tc were recorded. The percent crystallinity can be calculated by dividing the heat of fusion (Hf), determined from the second heat curve, by a theoretical heat of fusion of 292 J/g for PE (165 J/g for PP), and multiplying this quantity by 100 (for example, % cryst.=(Hf/292 J/g)×100 (for PE)).

### EXAMPLES

Examples 1 to 10 are synthetic procedures for intermediates of ligands, for ligands themselves, and for isolated metal-ligand complexes including the ligands. Example 11 describes polymerization results obtained from metal-ligand complexes prepared according to Examples 1-10. It should be understood that Examples 1-10 are provided to illustrate embodiments described in this disclosure and are not intended to limit the scope of this disclosure or its appended claims.

### Example 1—Synthesis of Metal-Ligand Complex 1 (MLC-1)

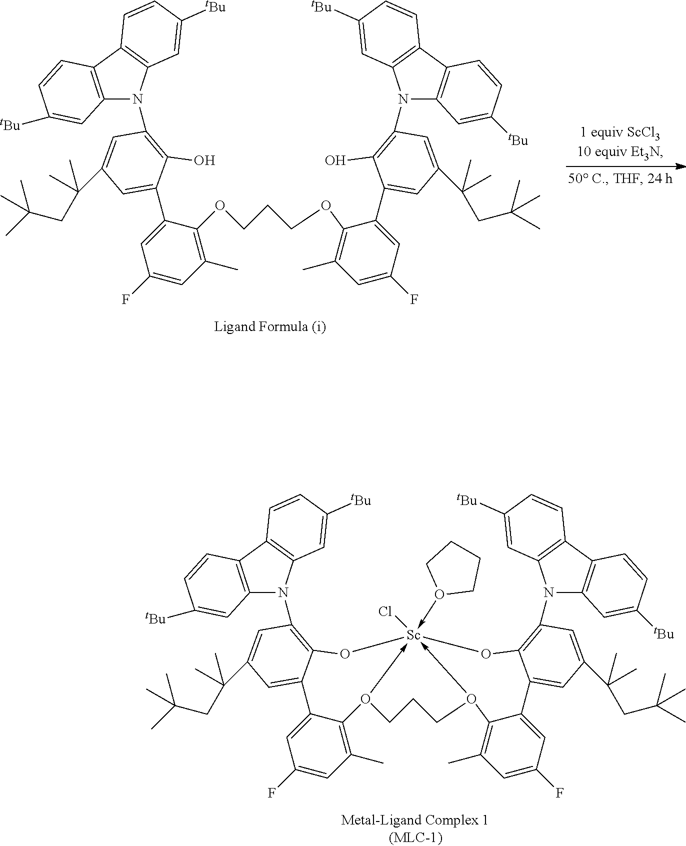

In a nitrogen-filled glovebox, a vial was charged with ScCl₃ (0.024 g, 0.16 mmol, 1 equiv) and 6 mL of THF. The mixture was stirred for 2 hours at 50° C. and then ligand i (0.200 g, 0.16 mmol, 1 equiv) was added as a solid, followed by Et₃N (0.22 mL, 1.59 mmol, 10 equiv). The reaction mixture was heated to 50° C. and stirred for an hour. The reaction mixture was evaporated to dryness under vacuum and the residue was extracted with 10 mL of hexanes. After filtration through Celite, the filtrate was evaporated under vacuum to give a white solid. ¹H NMR showed the desired product and a trace amount of Et₃N. The product was re-dissolved in hexanes (˜8 mL) and evaporated to dryness under vacuum. No amine was detected in the resulting white solid by ¹H NMR. The yield was quantitative when factoring in the samples taken for NMR.

¹H NMR (400 MHz, C₆D₆) δ 8.27 (dd, J=8.2, 0.7 Hz, 1H), 8.22 (d, J=8.2 Hz, 1H), 8.12 (d, J=8.2 Hz, 1H), 8.03 (d, J=1.6 Hz, 1H), 7.92 (d, J=8.2 Hz, 1H), 7.76 (d, J=2.6 Hz, 1H), 7.57 (d, J=1.6 Hz, 1H), 7.55-7.42 (m, 5H), 7.37 (d, J=1.6 Hz, 1H), 7.33 (d, J=2.7 Hz, 1H), 7.28 (d, J=2.6 Hz, 1H), 7.23 (dd, J=8.2, 1.7 Hz, 1H), 7.06 (dd, J=9.0, 3.2 Hz, 1H), 6.85 (dd, J=9.0, 3.2 Hz, 1H), 6.33 (dd, J=8.2, 3.1 Hz, 1H), 6.07 (dd, J=8.5, 3.2 Hz, 1H), 4.26 (dd, J=10.6, 8.0 Hz, 1H), 3.68 (t, J=9.3 Hz, 1H), 3.52 (dt, J=7.8, 3.6 Hz, 2H), 3.19 (dt, J=8.2, 6.1 Hz, 2H), 2.83 (dt, J=8.3, 6.2 Hz, 2H), 1.92 (s, 3H), 1.71-1.65 (m, 2H), 1.64 (s, 10H), 1.46 (s, 9H), 1.39 (d, J=7.7 Hz, 1H), 1.29 (s, 13H), 1.22 (d, J=7.1 Hz, 13H), 1.16 (d, J=9.1 Hz, 6H), 1.03 (s, 3H), 0.96 (d, J=6.6 Hz, 1H), 0.90 (d, J=9.5 Hz, 11H), 0.84 (s, 9H).

19F NMR (376 MHz, C6D6) δ −115.56, −116.20.

Preparation of ligand formula i detailed in WO2014105411 A1.

### Example 2—Synthesis of Metal-Ligand Complex 2 (MLC-2)

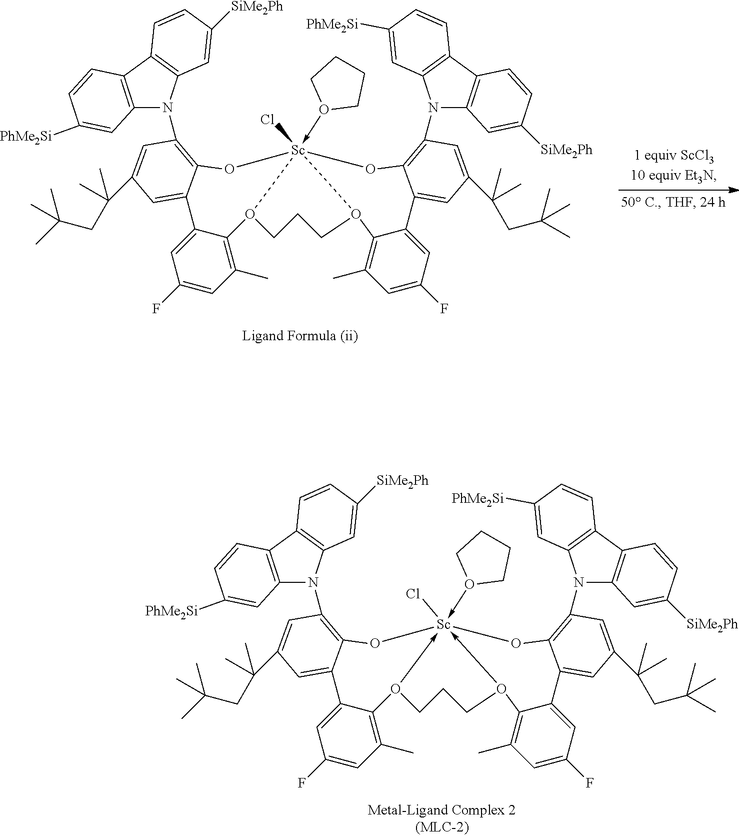

In a nitrogen-filled glovebox, a vial was charged with ScCl₃ (0.111 g, 0.73 mmol, 1.15 equiv) and 30 mL of THF. Ligand ii (1.000 g, 0.64 mmol, 1 equiv) was added as a solid, followed by Et₃N (0.89 mL, 6.38 mmol, 10 equiv). The reaction mixture was heated to 50° C. and stirred for 4 hours. A small sample was taken, evaporated to dryness under vacuum, mixed with C₆D₆ and checked by ¹H and ¹⁹F NMR. Only about 85% conversion to product was seen. More Et₃N (0.89 mL, 6.38 mmol, 10 equiv) was added, the reaction was heated to 60° C. and stirred for 3 hours. A sample showed no changes. The temperature was lowered to 50° C. and more ScCl₃ (0.014 g, 0.10 mmol, 0.15 equiv) was added. After 1.5 hours, a sample showed ˜97% conversion to product. The reaction mixture was allowed to cool to 25° C. and evaporated to dryness under vacuum overnight. The solid was triturated with pentane (10 mL) and evaporated to dryness under vacuum. This was followed by extraction of the solid with pentane (100 mL), filtration through a pad of Celite and solvent removal from the filtrate under vacuum to afford the product as a white solid (0.260 g). The filter cake was washed with toluene (40 mL), filtered and the solvent was removed under vacuum. This material was dissolved in methylene chloride (8 mL) giving a slightly hazy solution, which was filtered and solvent was removed under vacuum to give a white solid (0.721 g).

Total yield adjusted for NMR samples taken: 1.02 g, 93%.

¹H NMR (400 MHz, C₆D₆) δ 8.27 (dd, J=7.7, 2.6 Hz, 2H), 8.22 (s, 1H), 8.16 (d, J=7.7 Hz, 1H), 7.96 (d, J=7.7 Hz, 1H), 7.80 (d, J=11.7 Hz, 2H), 7.73-7.69 (m, 2H), 7.69-7.56 (m, 8H), 7.52 (ddt, J=8.2, 6.4, 1.5 Hz, 4H), 7.46 (d, J=2.6 Hz, 1H), 7.39 (dd, J=7.7, 0.8 Hz, 1H), 7.34-7.24 (m, 4H), 7.09-6.98 (m, 6H), 6.83 (dd, J=9.0, 3.3 Hz, 1H), 6.19 (ddd, J=11.9, 8.3, 3.2 Hz, 2H), 4.05-3.94 (m, 1H), 3.49-3.30 (m, 3H), 3.12-2.98 (m, 2H), 2.91-2.74 (m, 3H), 1.78-1.33 (m, 10H), 1.22 (d, J=16.1 Hz, 7H), 1.14 (d, J=5.4 Hz, 7H), 1.02 (s, 3H), 0.82 (d, J=6.2 Hz, 14H), 0.77 (s, 13H), 0.74-0.68 (m, 1H), 0.65 (d, J=12.0 Hz, 6H), 0.58 (s, 3H), 0.43 (d, J=7.5 Hz, 6H), 0.38 (s, 3H).

¹⁹F NMR (376 MHz, C₆D₆) δ −115.63, −116.04.

Preparation of ligand formula i detailed in WO2014105411 A1.

### Example 3—Synthesis of Metal-Ligand Complex 3 (MLC-3)

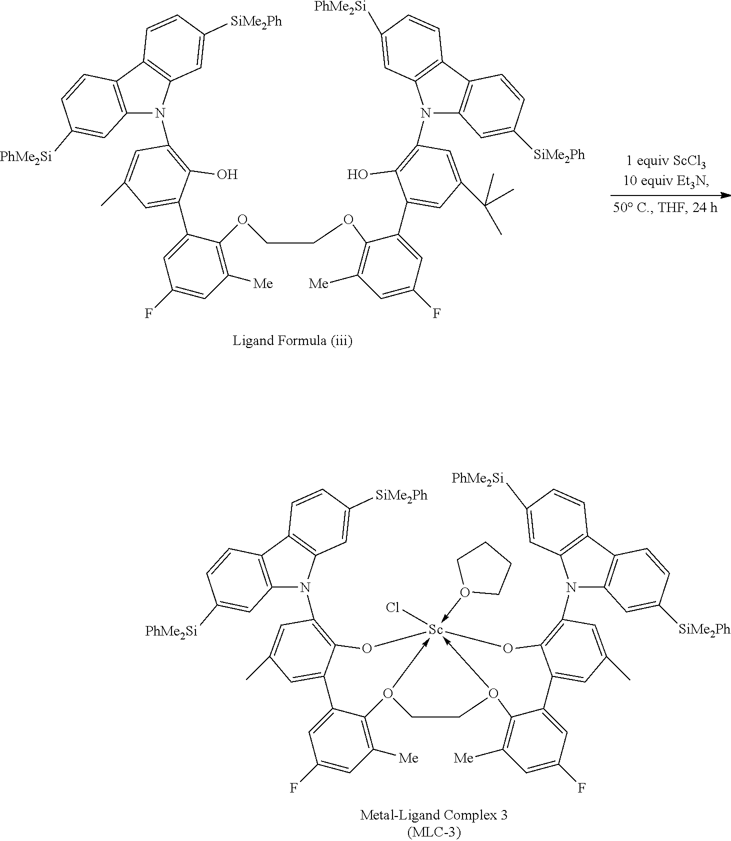

In a N₂ filled glovebox, a 20 mL vial was charged with ScCl₃ (9.6 mg, 0.063 mmol, 1.00 equiv) and 3 mL dry THF. The ligand formula (iii) was added (86 mg, 0.063 mmol, 1.00 equiv), followed by triethylamine (0.090 mL, 10 equiv). The mixture was stirred at 50° C. overnight. The solution was cooled and filtered through a 0.45 μm syringe filter. The filtrate was concentrated to dryness. The solid was suspended in 2 mL hexane. A white solid precipitated, which was isolated by filtration (60.6 mg, 64%).

¹H NMR (500 MHz, C₆D₆) δ 8.34 (d, J=7.6 Hz, 1H), 8.23 (d, J=7.7 Hz, 1H), 8.13 (d, J=7.8 Hz, 1H), 8.02-7.96 (m, 2H), 7.85 (s, 1H), 7.73-7.61 (m, 8H), 7.59-7.50 (m, 6H), 7.34-7.17 (m, 6H), 7.15-6.99 (m, 8H), 6.93 (s, 1H), 6.87 (s, 1H), 6.77-6.66 (m, 2H), 6.24-6.14 (m, 2H), 4.21 (td, J=9.2, 5.3 Hz, 1H), 4.08 (t, J=10.0 Hz, 1H), 3.04-2.84 (m, 3H), 2.71-2.51 (m, 3H), 2.12 (s, 3H), 2.08 (s, 3H), 1.73 (s, 3H), 1.30 (s, 3H), 0.72 (s, 3H), 0.70 (s, 3H), 0.68 (s, 3H), 0.66 (s, 3H), 0.59 (s, 3H), 0.52 (s, 3H), 0.45-0.38 (m, 7H), 0.31 (s, 3H).

¹³C NMR (126 MHz, C₆D₆) δ 161.31, 160.71, 159.36, 158.76, 155.44, 155.38, 146.81, 146.57, 146.55, 142.13, 141.84, 140.72, 139.96, 139.45, 139.04, 138.87, 138.52, 137.44, 135.36, 135.29, 134.78, 134.50, 134.40, 134.27, 133.96, 133.82, 133.74, 133.57, 133.50, 131.14, 131.03, 130.55, 129.28, 129.24, 128.90, 128.68, 128.58, 128.56, 128.40, 128.19, 127.30, 127.16, 125.96, 125.80, 125.75, 125.65, 125.60, 125.06, 125.04, 124.81, 124.34, 123.25, 120.38, 120.11, 119.83, 119.21, 118.91, 118.00, 117.92, 117.81, 117.33, 116.93, 116.75, 116.65, 116.57, 115.53, 115.35, 72.04, 71.14, 68.35, 23.85, 19.99, 19.93, 17.68, 16.59, −1.62, −1.72, −1.78, −1.84, −2.28, −2.36, −2.38, −2.59.

¹⁹F NMR (471 MHz, C₆D₆) δ −115.80 (t, J=8.8 Hz), —116.12 (t, J=9.0 Hz).

### Example 3-1—Synthesis of 2,7-bis(dimethyl(phenyl)silyl)-9-(5-methyl-2-((tetrahydro-2H-pyran-2-yl)oxy)phenyl)-9H-carbazole

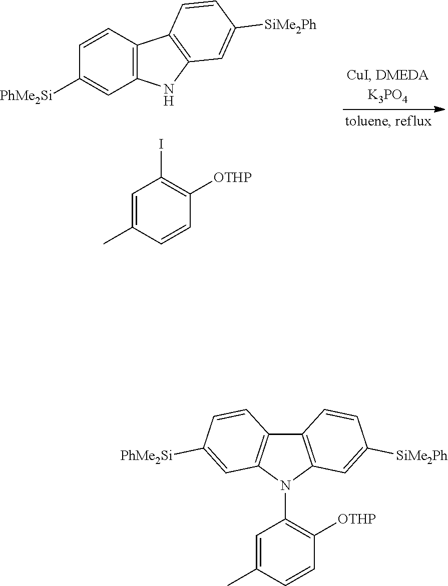

In a N₂ filled glovebox, a 100 mL round bottom flask was charged with 2,7-bis(dimethyl(phenyl)silyl)-9H-carbazole (5.00 g, 11.5 mmol, 1.00 equiv), 2-(2-iodo-4-methylphenoxy)tetrahydro-2H-pyran (5.11 g, 16.1 mmol, 1.40 equiv), K₃PO₄ (7.55 g, 35.6 mmol, 3.10 equiv), CuI (0.481 g, 2.53 mmol, 22.0 mol %), 28 mL dry toluene, and DMEDA (0.877 mL, 8.15 mmol, 71.0 mol %). A coiled reflux condenser was attached to the round bottom flask and stirred the reaction mixture at 120° C. in the glovebox for 24 hours. The solution was cooled, and the reaction mixture was filtered. The filter cake was rinsed with a few portions of dichloromethane. The filtrate was concentrated and the residue purified by chromatography on silica gel (0 to 50% dichloromethane in hexane) to give desired product. (3.06 g, 43%).

¹H NMR (400 MHz, CDCl₃) δ 8.10 (d, J=7.7 Hz, 2H), 7.54-7.47 (m, 4H), 7.45 (s, 1H), 7.42-7.37 (m, 2H), 7.37-7.26 (m, 8H), 7.26-7.17 (m, 2H), 5.13 (d, J=3.1 Hz, 1H), 3.53 (td, J=11.0, 2.6 Hz, 1H), 3.35 (dt, J=11.2, 3.9 Hz, 1H), 2.34 (s, 3H), 1.47-1.21 (m, 2H), 1.19-1.01 (m, 4H), 0.55 (s, 12H).

¹³C NMR (101 MHz, CDCl₃) δ 151.01, 141.03, 138.91, 138.84, 135.11, 135.04, 134.16, 131.83, 129.75, 129.63, 128.92, 128.90, 127.67, 126.52, 125.08, 124.95, 123.88, 119.57, 119.55, 117.26, 116.29, 116.20, 97.09, 61.49, 29.98, 24.86, 20.52, 17.79, −1.97, −2.07, −2.09, −2.13.

Preparation of 2,7-bis(dimethyl(phenyl)silyl)-9H-carbazole detailed in WO 2021155158.

### Example 3-2—Synthesis of Ligand Formula (iii)

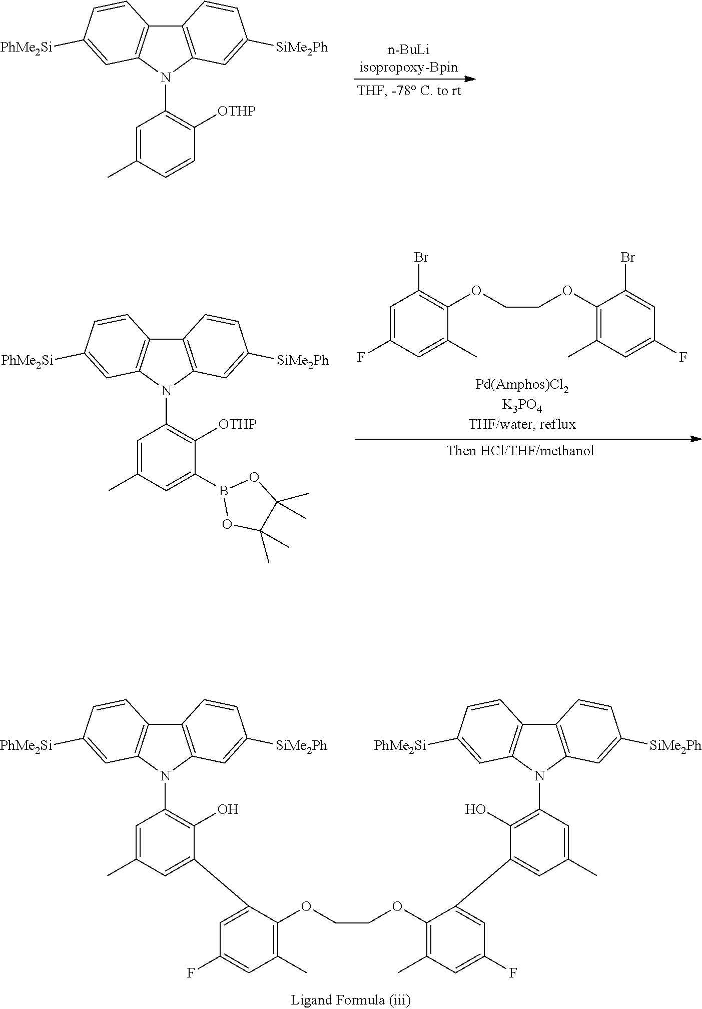

A 500 mL round bottom flask was charged with 2,7-bis(dimethyl(phenyl)silyl)-9-(5-methyl-2-((tetrahydro-2H-pyran-2-yl)oxy)phenyl)-9H-carbazole (23.8 g, 38.0 mmol, 1.00 equiv) and 190 mL dry THF. The solution was placed under nitrogen, and was cooled to −78° C. N-butyllithium (2.5 M in hexane, 16.7 mL, 41.8 mmol, 1.10 equiv) was added dropwise. The mixture was slowly warmed to 0° C. and was allowed to stir for 90 minutes. A white solid precipitated during this time. The slurry was treated with 2-isopropoxy-4,4,5,5-tetramethyl-1,3,2-dioxaborolane (9.31 mL, 45.6 mmol, 1.20 equiv) and stirring continued for 1 hour.

The solution was quenched with aq. ammonium chloride, and product was extracted with several portions of dichloromethane. Combined organic fractions were dried with Na₂SO₄ and concentrated to a pale yellow residue. This material was taken on to the next step without further purification.

A 500 mL round bottom flask was charged with boronic ester (2.2 equiv), 1,2-bis(2-bromo-4-fluoro-6-methylphenoxy) ethane (7.50 g, 17.2 mmol, 1.00 equiv), and Pd(Amphos) C₁₂ (609 mg, 0.860 mmol, 5.00 mol %). A reflux condenser was attached and the unit was placed under a blanket of nitrogen. 170 mL of dry, degassed THF was added, followed by nitrogen-sparged aqueous K₃PO₄ (2.0 M in water, 51.6 mL, 0.103 mol, 6.00 equiv). The mixture was stirred at 70° C. overnight.

The solution was cooled and the phases were separated. The aqueous phase was extracted with portions of dichloromethane. Combined organic fractions were washed with brine, dried with Na₂SO₄, and filtered through a plug of silica gel. The filtrate was concentrated to give a crude oil. The oil was dissolved in 150 mL THF, 50 mL MeOH, and 25 mL of 6 M HCl. The mixture was refluxed for 3 hours. The solution was cooled and diluted with dichloromethane and brine. The phases were separated, and the aqueous phase extracted with several portions of dichloromethane. The combined organic fractions were washed with aq. Sodium bicarbonate solution. The organic phase was dried with Na₂SO₄ and concentrated. The residue was purified by chromatography on silica gel (0 to 10% EtOAc in hexane) to give 19.73 g product (85%).

¹H NMR (500 MHz, CDCl₃) δ 8.12 (d, J=7.8 Hz, 4H), 7.46-7.35 (m, 12H), 7.28-7.23 (m, 4H), 7.23-7.16 (m, 14H), 7.09 (s, 2H), 6.90 (dd, J=8.8, 3.1 Hz, 2H), 6.71 (dd, J=8.7, 3.1 Hz, 2H), 6.35 (s, 2H), 3.42 (s, 4H), 2.26 (s, 6H), 1.68 (s, 6H), 0.44 (s, 12H), 0.39 (s, 12H).

¹³C NMR (126 MHz, CDCl₃) δ 159.11 (d, J=243.7 Hz), 149.14 (d, J=2.4 Hz), 147.76, 140.99, 138.51, 135.52, 134.15, 134.02 (d, J=9.0 Hz), 132.34 (d, J=8.7 Hz), 131.63, 130.58, 130.05, 128.91, 127.60, 126.70, 125.60, 125.33, 123.99, 119.84, 117.28 (d, J=22.5 Hz), 115.89 (d, J=23.4 Hz), 115.61, 72.09, 20.41, 15.61, −2.10, −2.20.

¹⁹F NMR (471 MHz, CDCl₃) δ −117.74 (t, J=7.7 Hz).

### Example 4—Synthesis of Metal-Ligand Complex 4 (MLC-4)

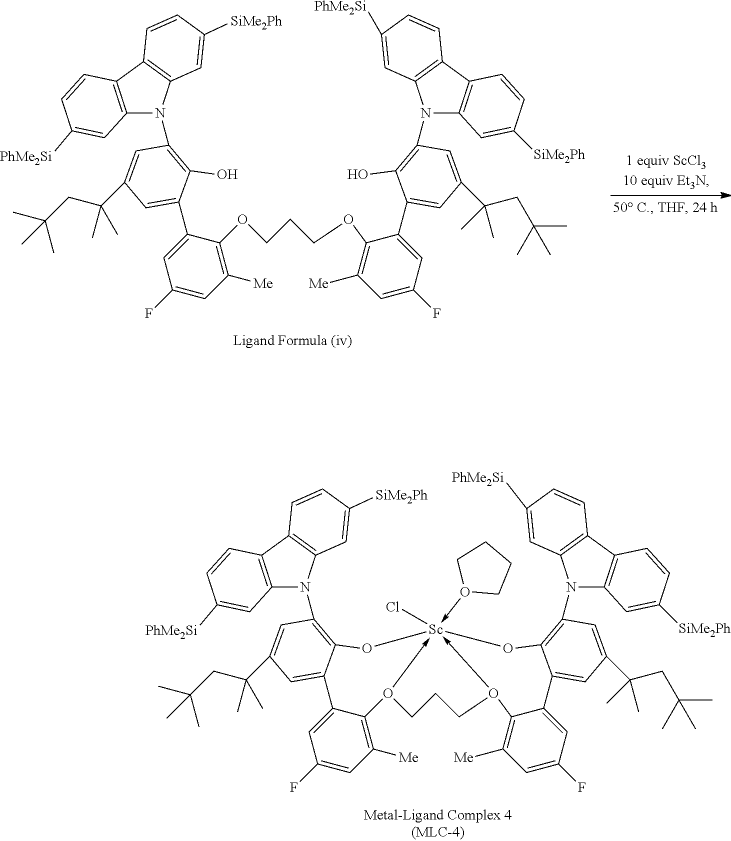

In a N₂ filled glovebox, a 20 mL vial was charged with ScCl₃ (35.1 mg, 0.232 mmol, 1.00 equiv) and 11 mL dry THF. The ligand formula (iv) was added (421 mg, 0.232 mmol, 1.00 equiv), followed by triethylamine (0.33 mL, 10 equiv). The mixture was stirred at 50° C. overnight. Another 7 mg ScCl₃ was added with 0.066 mL triethylamine. Stirring continued for 6 hours. At this point, NMR indicated that starting material was consumed. The solution was cooled in a glovebox freezer and filtered through a 0.45 μm syringe filter. The filtrate was concentrated to dryness. The solid was mixed with 3 mL dry hexane, and liquid was removed by decantation. The solid was rinsed with two additional portions of hexane. The final white solid was dried to give 0.371 g of material (81%).

¹H NMR (500 MHz, C₆D₆) δ 8.23 (d, J=7.7 Hz, 1H), 8.19-8.14 (m, 2H), 8.11 (d, J=7.7 Hz, 1H), 7.94 (d, J=7.7 Hz, 1H), 7.89 (s, 1H), 7.80 (s, 1H), 7.78-7.75 (m, 2H), 7.74-7.70 (m, 2H), 7.66 (dddd, J=14.9, 7.4, 4.4, 2.1 Hz, 11H), 7.61-7.54 (m, 5H), 7.53 (d, J=2.7 Hz, 1H), 7.47 (dd, J=7.7, 0.9 Hz, 1H), 7.45 (d, J=2.6 Hz, 1H), 7.33-7.17 (m, 14H), 7.15-7.01 (m, 12H), 6.97 (dd, J=8.8, 3.2 Hz, 1H), 6.72 (dd, J=8.9, 3.2 Hz, 1H), 6.24 (dd, J=8.5, 3.2 Hz, 1H), 6.16 (dd, J=8.3, 3.2 Hz, 1H), 3.89 (ddd, J=10.9, 7.6, 1.9 Hz, 1H), 3.48-3.29 (m, 3H), 2.95 (qd, J=6.9, 2.8 Hz, 2H), 2.74 (qd, J=6.6, 2.7 Hz, 2H), 1.56-0.64 (m, 64H).

¹³C NMR (126 MHz, C₆D₆) δ 161.52, 160.99, 159.57, 159.03, 155.78, 155.66, 149.23, 149.21, 149.00, 148.97, 142.80, 142.02, 141.20, 141.02, 138.08, 137.26, 137.11, 137.01, 136.95, 136.89, 136.75, 136.69, 136.43, 136.03, 135.96, 135.79, 135.78, 135.76, 135.71, 135.68, 135.65, 135.55, 135.48, 135.44, 135.42, 135.37, 135.28, 134.75, 134.68, 133.21, 132.39, 132.33, 129.67, 129.53, 129.29, 129.23, 129.07, 129.04, 129.00, 128.84, 128.79, 128.60, 128.47, 128.08, 128.05, 127.19, 126.76, 126.69, 126.58, 126.23, 126.10, 125.46, 124.75, 124.25, 123.28, 120.56, 120.21, 120.10, 120.00, 119.36, 119.23, 118.60, 117.74, 117.63, 117.10, 116.92, 115.99, 115.81, 115.47, 115.30, 77.65, 75.20, 72.25, 57.37, 56.69, 37.53, 37.43, 34.62, 32.73, 32.30, 32.11, 32.09, 31.67, 31.63, 31.60, 30.16, 30.13, 30.05, 29.97, 24.29, 22.68, 17.15, 16.17, 13.97, −2.67, −2.91, −2.95.

¹⁹F NMR (471 MHz, C₆D₆) δ −115.59 (t, J=8.5 Hz), —115.92 (t, J=8.1 Hz).

### Example 4-1—Synthesis of 2,7-bis(methyldiphenylsilyl)-9H-carbazole

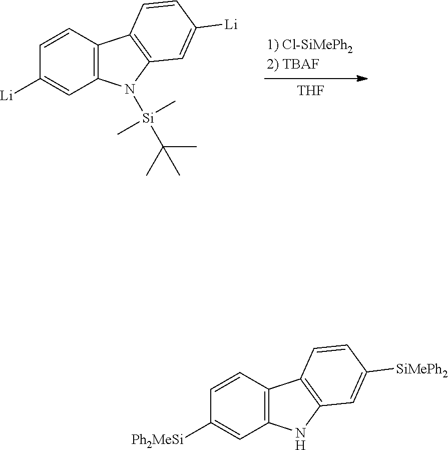

In a N₂ filled glovebox, a 50 mL jar was charged with 2,7-dilithio-9-(tert-butyldimethylsilyl)-9H-carbazole (2.00 g, 6.82 mmol, 1.00 equiv) and 34 mL dry THF. Chloromethyldiphenylsilane (3.01 mL, 14.3 mmol, 2.10 equiv) was added, and the mixture stirred for 45 minutes. Solid organolithium quickly dissolved as the reaction progressed.

The clear, colorless solution was quenched with aq. ammonium chloride. Product was extracted with several portions of dichloromethane. Combined organic fractions were concentrated. The solution was dried with Na₂SO₄, filtered through basic alumina, and concentrated to a white solid. A crude oil was isolated.

The carbazole was dissolved in 34 mL THF, and was treated with tetrabutylammonium fluoride trihydrate (2.15 g, 6.82 mmol, 1.00 equiv). The mixture stirred for 20 minutes, and the solution was quenched with aq. NaHCO₃. Product was extracted with several portions of dichloromethane. Combined organic fractions were concentrated, and the residue was purified by chromatography on silica gel (0 to 20% EtOAc in hexane). 2.213 g of product was isolated as a white solid (58% over two steps).

¹H NMR (500 MHz, CDCl₃) δ 8.06 (dt, J=7.8, 0.7 Hz, 2H), 7.71 (s, 1H), 7.57-7.49 (m, 8H), 7.47 (t, J=0.9 Hz, 2H), 7.44-7.30 (m, 14H), 0.89 (s, 6H).

¹³C NMR (126 MHz, CDCl₃) δ 139.29, 136.44, 135.36, 133.73, 129.37, 127.85, 125.86, 124.02, 120.02, 117.81, −3.10.

### Example 4-2—Synthesis of 2,7-bis(methyldiphenylsilyl)-9-(2-((tetrahydro-2H-pyran-2-yl)oxy)-5-(2,4,4-trimethylpentan-2-yl)phenyl)-9H-carbazole

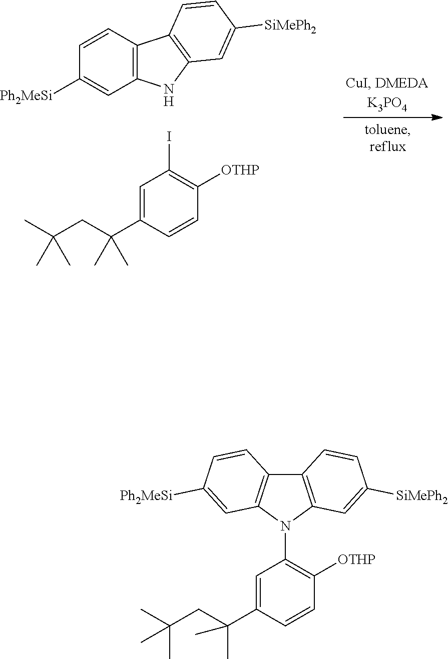

In a N₂ filled glovebox, a 1000 mL round bottom flask is charged with 2,7-bis(methyldiphenylsilyl)-9H-carbazole (64.00 g, 114.3 mmol, 1.00 equiv), 2-(2-iodo-4-(2,4,4-trimethylpentan-2-yl) phenoxy)tetrahydro-2H-pyran (85.67 g, 205.8 mmol, 1.80 equiv), K₃PO₄ (75.22 g, 354.4 mmol, 3.10 equiv), CuI (4.79 g, 25.1 mmol, 22.0 mol %), 286 mL dry toluene, and DMEDA (8.74 mL, 81.2 mmol, 71.0 mol %). A coiled reflux condenser was attached, and the reaction mixture was stirred at 120° C. After 6.5 hours, partial conversion was observed by TLC. Another charge/batch of CuI and DMEDA was added (22% and 71% respectively).

24 hours after the start of the reaction, another charge of CuI and DMEDA was added (22% and 71% respectively), along with 10 g of the iodide. Stirring continued for 24 hours.

The solution was cooled, and filtered to remove solids. The solid cake was rinsed with dichloromethane (3×100 mL). The filtrate was concentrated, and the residue purified by chromatography on silica gel (0 to 10% EtOAc in hexane). A white solid residue was isolated, which was suspended in 250 mL of cold hexane. The slurry was filtered to remove the bulk solid and the solid was rinsed with additional hexane portions (3×50 mL). The solid was dried under vacuum to give 78.369 g of product as a clean, white solid (81%).

¹H NMR (500 MHz, CDCl₃) δ 8.12 (d, J=7.7 Hz, 2H), 7.49 (d, J=7.6 Hz, 7H), 7.46 (s, 1H), 7.43 (s, 1H), 7.39-7.26 (m, 17H), 7.20 (d, J=8.6 Hz, 1H), 5.05 (d, J=3.4 Hz, 1H), 3.45-3.34 (m, 1H), 3.26 (dt, J=11.2, 3.7 Hz, 1H), 1.64 (s, 2H), 1.27 (d, J=7.9 Hz, 8H), 1.06 (td, J=17.0, 16.6, 5.2 Hz, 4H), 0.81 (d, J=3.9 Hz, 6H), 0.65 (s, 9H).

¹³C NMR (126 MHz, CDCl₃) δ 150.87, 143.99, 141.35, 141.30, 136.66, 136.61, 136.59, 135.30, 135.29, 135.26, 135.25, 133.25, 133.08, 129.26, 129.24, 127.76, 127.74, 127.32, 126.92, 126.16, 125.97, 125.61, 124.01, 123.96, 119.70, 117.31, 117.14, 116.07, 96.86, 61.47, 56.94, 38.09, 32.32, 31.73, 31.64, 31.52, 30.04, 24.85, 17.88, −3.06, −3.12.

### Example 4-3—Synthesis of 2,7-bis(methyldiphenylsilyl)-9-(2-((tetrahydro-2H-pyran-2-yl)oxy)-3-(4,4,5,5-tetramethyl-1,3,2-dioxaborolan-2-yl)-5-(2,4,4-trimethylpentan-2-yl)phenyl)-9H-carbazole

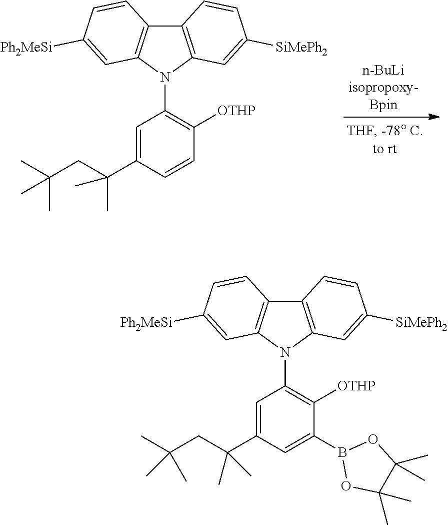

A 1000 mL round bottom flask was charged with 2,7-bis(methyldiphenylsilyl)-9-(2-((tetrahydro-2H-pyran-2-yl)oxy)-5-(2,4,4-trimethylpentan-2-yl)phenyl)-9H-carbazole (77.5 g, 91.4 mmol, 1.00 equiv) and 450 mL dry THF. The solution was placed under nitrogen, and was cooled to −78° C. N-butyllithium (2.5 M in hexane, 40.2 mL, 100.5 mmol, 1.10 equiv) was added dropwise. The mixture was slowly warmed to 0° C. and was allowed to stir for 90 minutes. A white solid precipitated during this time.

The slurry was treated with 2-isopropoxy-4,4,5,5-tetramethyl-1,3,2-dioxaborolane (22.4 mL, 110 mmol, 1.20 equiv) and stirring continued for 1 hour. The solution was quenched with aq. ammonium chloride, and product was extracted with several portions of dichloromethane. Combined organic fractions were dried with Na₂SO₄ and concentrated to a white solid (87.92 g). This material was used without further purification.

¹H NMR (500 MHz, CDCl₃) δ 8.09 (dd, J=7.7, 2.4 Hz, 2H), 7.74 (d, J=2.6 Hz, 1H), 7.60-7.39 (m, 11H), 7.33 (ddd, J=20.2, 13.7, 8.0 Hz, 14H), 4.95 (d, J=3.2 Hz, 1H), 2.61-2.41 (m, 2H), 1.63 (d, J=9.7 Hz, 3H), 1.35 (d, J=4.1 Hz, 11H), 1.27 (d, J=24.0 Hz, 7H), 1.12 (dt, J=19.2, 10.0 Hz, 3H), 0.94-0.85 (m, 1H), 0.82 (d, J=6.5 Hz, 6H), 0.64 (s, 9H).

¹³C NMR (126 MHz, CDCl₃) δ 155.94, 145.59, 140.96, 140.85, 136.71, 136.67, 136.65, 136.62, 135.28, 135.26, 135.22, 135.19, 134.04, 133.27, 132.96, 129.99, 129.12, 129.08, 129.07, 128.85, 127.79, 127.72, 127.71, 127.69, 126.05, 125.92, 124.09, 123.66, 119.54, 119.47, 118.20, 117.28, 101.22, 83.51, 60.97, 56.84, 38.22, 32.29, 31.75, 31.59, 31.01, 29.89, 25.03, 24.99, 24.77, 18.09, −3.09.

### Example 4-4—Synthesis of Ligand Formula (iv)

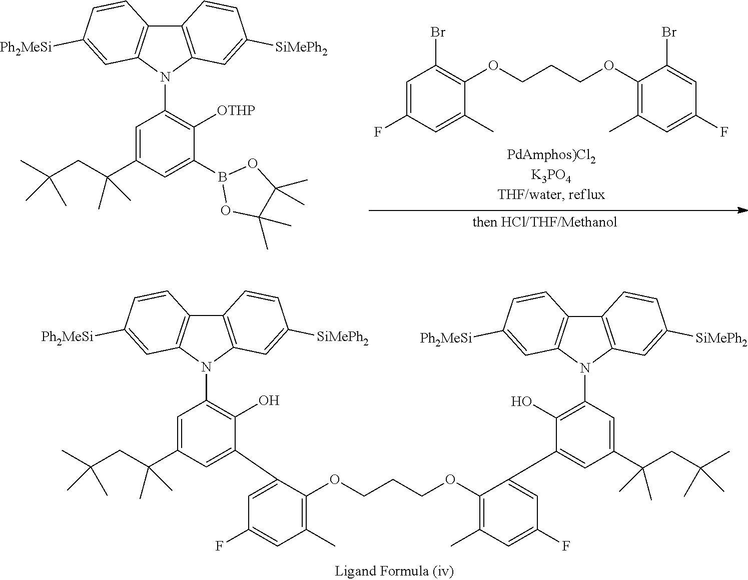

A 1 L round bottom flask was charged with 2,7-bis(methyldiphenylsilyl)-9-(2-((tetrahydro-2H-pyran-2-yl)oxy)-3-(4,4,5,5-tetramethyl-1,3,2-dioxaborolan-2-yl)-5-(2,4,4-trimethylpentan-2-yl)phenyl)-9H-carbazole (35.15 g, 36.08 mmol, 2.80 equiv), 1,3-bis(2-bromo-4-fluoro-6-methylphenoxy) propane (5.80 g, 12.9 mmol, 1.00 equiv), and Pd(Amphos)Cl₂ (456 mg, 0.644 mmol, 5.00 mol %). A reflux condenser was attached and the unit was placed under a blanket of nitrogen. Degassed, dry THF (128 mL) was added, followed by nitrogen-sparged aqueous K₃PO₄ (2.0 M in water, 38.7 mL, 77.3 mmol, 6.00 equiv). The mixture was stirred at 70° C. overnight.

The solution was cooled and diluted with dichloromethane and brine. The aqueous phase was extracted with portions of dichloromethane. The combined organic fractions were concentrated, and the residue purified by chromatography on silica gel (0 to 10% EtOAc in hexane) to give approximately 24 g of a white solid. The white solid was dissolved in 128 mL THF, 12.8 mL MeOH, and 4.3 mL 6 M HCl. The mixture was stirred at 50° C. overnight.

The solution was cooled and diluted with 100 mL dichloromethane and sat. aq. sodium bicarbonate solution. Phases were separated, and the aqueous phase was extracted by several additional portions of dichloromethane. The organic phase was separated, concentrated, and the residue purified by chromatography on silica gel (0 to 10% EtOAc in hexane). The residue was heated in 200 mL of acetonitrile, then allowed to cool. The clean, white solid was isolated by filtration and was dried under vacuum. 19.16 g of product was isolated (82%).

¹H NMR (500 MHz, CDCl₃) § 8.13 (dd, J=7.6, 2.2 Hz, 4H), 7.46-7.35 (m, 22H), 7.31 (s, 4H), 7.26-7.08 (m, 26H), 6.76 (t, J=8.1 Hz, 4H), 6.53 (s, 2H), 3.24 (t, J=6.4 Hz, 4H), 1.69-1.57 (m, 10H), 1.35-1.14 (m, 14H), 0.71 (s, 12H), 0.61 (s, 18H).

¹³C NMR (126 MHz, CDCl₃) δ 159.90, 157.96, 149.74, 147.35, 142.86, 140.94, 136.38, 136.25, 135.18, 133.65, 133.58, 133.53, 132.81, 132.75, 129.17, 129.14, 128.74, 127.66, 127.63, 127.16, 126.39, 124.86, 124.17, 119.91, 117.20, 117.02, 116.20, 116.02, 71.07, 56.99, 38.08, 32.26, 31.70, 31.50, 30.28, 16.04, −3.06.

¹⁹F NMR (471 MHz, CDCl₃) δ −118.20.

### Example 3—Synthesis of Metal-Ligand Complex 3 (MLC-3)

### Synthesis of 2,7-dibromo-9-(tert-butyldimethylsilyl)-9H-carbazole-2,7-dibromo-9H-carbazole

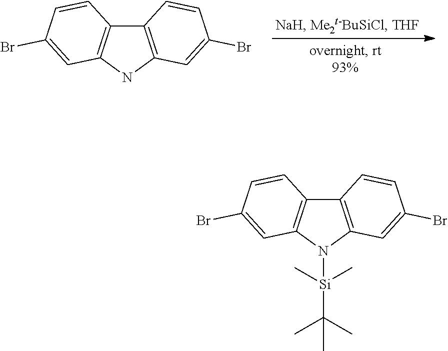 [SMILES: Brc1ccc2c(c1)[nH]c1cc(Br)ccc12 ; CC(C)(C)[Si](C)(C)n1c2cc(Br)ccc2c2ccc(Br)cc21]

A glass jar with a stir bar was charged in a glove box with 2,7-dibromo-9H-carbazole (50.0 g, 154 mmol, 1 equiv.) followed by dry THF (300 mL). Sodium hydride powder (90%) (4.5 g, 169 mmol, 1.1 equiv.) was added slowly in portions to the solution over a period of 30 min. After allowing to stir at room temperature for 60 min, t-butyl-dimethylsilyl chloride (44.2 g, 231 mmol, 1.5 equiv.) was added to the reaction mixture. The solution was stirred 17 hr at room temperature. The reaction mixture was taken out of the glovebox and THF as evaporated and filtered through a frit funnel. Then washed the white solid with 25 mL of THF and transferred the white solid to a 50 mL jar. 40 mL of water was added to the jar to quench excess NaH. Then acetone (3×30 mL) was used to remove the water in the product. The white solid was filtered through a frit funnel and acetone was added to wash the cake. Then the white solid was transferred to a 500 mL RB and dried the solid under vacuum for overnight. yield (62.5 g, 93%).

¹H NMR (500 MHz, Chloroform-d) δ 7.85 (dd, J=8.3, 1.7 Hz, 2H), 7.73 (d, J=1.8 Hz, 2H), 7.35 (dd, J=8.2, 2.2 Hz, 2H), 1.05 (d, J=1.9 Hz, 9H), 0.76 (d, J=1.8 Hz, 6H).

¹³C NMR (126 MHz, CDCl₃) δ 146.2, 124.8, 123.4, 121.0, 119.4, 117.3, 26.7, 20.6, −1.1.

### Synthesis of 2,7-bis(triisobutylsilyl)-9H-carbazole

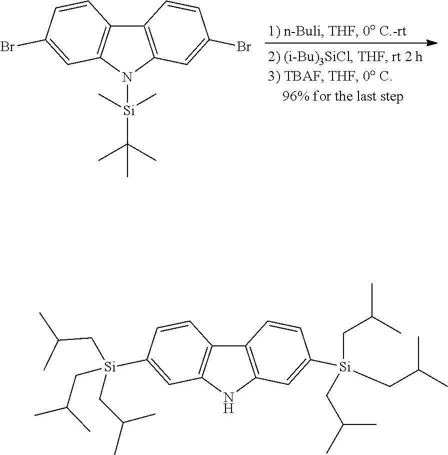 [SMILES: CC(C)(C)[Si](C)(C)n1c2cc(Br)ccc2c2ccc(Br)cc21 ; CC(C)C[Si](CC(C)C)(CC(C)C)c1ccc2c(c1)[nH]c1cc([Si](CC(C)C)(CC(C)C)CC(C)C)ccc12]

A 500 mL round bottom flask was charged with 2,7-dibromo-9-(tert-butyldimethylsilyl)-9H-carbazole (24 g, 55 mmol, 1 equiv.) and 250 mL dry THF. The RB was kept under nitrogen atmosphere and stirred at −78° C. for 15 mins. Then 2.5 M n-BuLi solution in hexane (46 mL, 114.7 mmol, 2.1 equiv.) was added to the reaction mixture in a dropwise matter for 15 minutes. The solution color turns into faint yellow and became heterogeneous white slurry. Since the generated di-lithio salt is heterogeneous in nature, the stirring of the reaction stops. Consequently, the reaction mixture requires manual stirring a few times for proper mixing of reagents. The heterogeneous slurry was stirred for 30 minutes at −78° C. Then the reaction mixture was kept in an ice bath for 15 minutes and then chlorotriisobutylsilane (34 mL, 126 mmol, 2.3 equiv.) was added to the heterogeneous slurry at 0° C. After addition of chlorosilane, the heterogeneous reaction mixture became homogenous (colorless) within 15 minutes. The reaction mixture was stirred for 30 minutes more. Then 120 mL NaHCO₃ solution was added, and the organic layer was extracted with EtOAc (50×3). The combined organic layer was dried with Na₂SO₄. The solvent was evaporated under reduced pressure. White solid crashed out. The white solid was washed twice with Acetonitrile and EtOH (20:4) mixture total 60 mL solvent. The white solid was filtered through frit funnel and dried under vacuum 36 g of white solid was obtained.

9-(tert-butyldimethylsilyl)-2,7-bis(triisobutylsilyl)-9H-carbazole (20 g, 29.5 mmol, 1 equiv.) was taken in a 250 mL RB and dry THF was added under N₂ atmosphere. The solution was stirred for 15 minutes at 0° C. At 0° C., TBAF·3H₂O (9.7 g, 31 mmol, 1.05 equiv.) solution in dry THF (15 mL) was added dropwise to the solution. The reaction mixture turned from colorless to faint yellow. The progress of the reaction was monitored by TLC. The reaction was done within 10 mins. 100 mL of NaHCO₃ solution was added to quench the reaction. The organic layer was extracted with (4×70 mL) of DCM. The combined organic layer was dried with Na₂SO₄. The solvent was evaporated under reduced pressure. The faint yellow oil was directly loaded onto ISCO column. 50% DCM in hexane gradient was used. The white solid product came out at 30% DCM in hexane. Yield (16 g, 96% for the second step).

Alternatively, the crude deprotected product was purified by recrystallizing from ACN: Ethanol (10:1) mixture. The crude yellow color liquid was dissolved in 20 mL: 2 mL ACN: Ethanol mixture. The RB containing the mixture was kept into a freezer for 1d. The solid product crashed out from the solvent. Then solid product was washed with acetonitrile: acetone mixture twice (30 mL: 5 mL) to obtain the white solid product. Washing the solid product with acetonitrile: acetone mixture helps removing the impurities. Although the yield in this case, is relatively lower as compared to the column purification technique. Yield (12 g, 72%)

¹H NMR (400 MHz, Chloroform-d) δ 8.07-8.01 (m, 2H), 7.95 (s, 1H), 7.59 (d, J=0.9 Hz, 2H), 7.37 (dd, J=7.8, 0.9 Hz, 2H), 1.82 (dq, J=13.3, 6.6 Hz, 6H), 0.91 (dd, J=13.4, 6.7 Hz, 48H).

¹³C NMR (101 MHz, CDCl₃) δ 139.4, 137.0, 125.2, 123.7, 119.6, 116.4, 26.7, 25.1, 24.6.

### Synthesis of 9-(2-((tetrahydro-2H-pyran-2-yl)oxy)-5-(2,4,4-trimethylpentan-2-yl)phenyl)-2,7-bis(triisobutylsilyl)-9H-carbazole

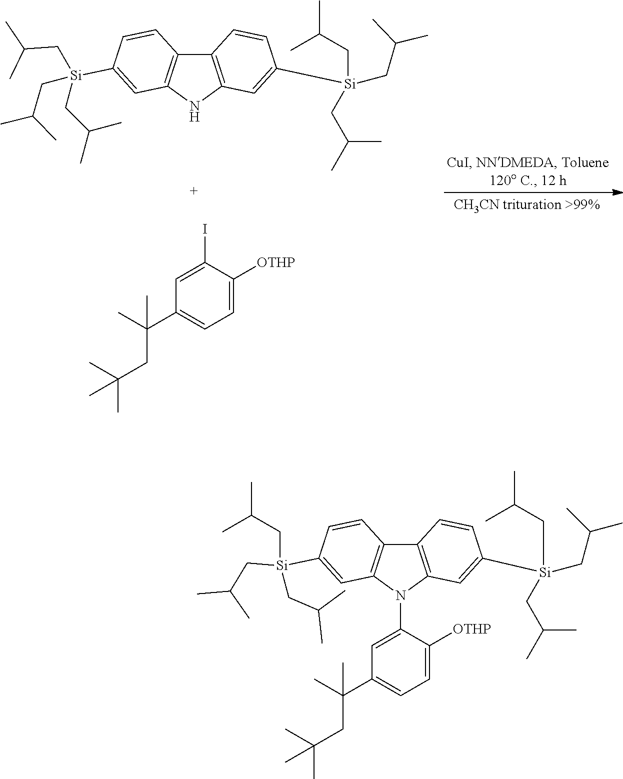

A 500 mL round bottom flask was charged with 2,7-bis(triisobutylsilyl)-9H-carbazole (11.5 g, 20.4 mmol, 1 equiv.), 2-(2-iodo-4-(2,4,4-trimethylpentan-2-yl) phenoxy)tetrahydro-2H-pyran (13.6 g, 32.6 mmol, 1.6 equiv.), K₃PO₄ (19.5 g, 92 mmol, 4.5 equiv.). The RB was brought into a N₂-filled glovebox and CuI (1.6 g, 8.2 mmol, 0.4 equiv.), NN′DMEDA (2.2 g, 24.5 mmol, 1.2 equiv.), and dry and degassed toluene (50 mL) were added to it. The heterogeneous reaction mixture was stirred at 125° C. with vigorous stirring for 48 h. Initially the reaction color was faint yellow but after 1 h, it turned into green and stayed green for a while. After 48 h, the reaction color turned into brown. After 48 h, the crude NMR was taken in chloroform, which shows complete consumption of carbazole and proto de-halogenated THP protected phenol. The reaction mixture was cooled down in the glovebox. After that, the reaction mixture was taken out of the glovebox and filtered through neutral alumina in a frit funnel. The solid in the frit funnel was washed with 70 mL of EtOAc. Then the brown filtrate was evaporated under vacuum. The sticky orange, brown liquid was dissolved in dichloromethane:hexane (1:1) mixture and filtered through a frit funnel containing neutral alumina and washed the neutral alumina with 30 ml of DCM:hexanes (1:1) mixture. The filtrate was concentrated under reduced pressure. The method was repeated thrice in order to get rid of all the Copper salts and other metal-based impurities. The faint yellow colored oily material was dissolved in 60 mL of acetonitrile and stirred vigorously (1500 rpm) at 45° C. for 20 minutes. Then cool it down and kept it in the freezer for 30 minutes. Then the solvent was decanted. The brown oil was washed thrice (30 mL) with cold acetonitrile and decanted the solvent. The brown oil was dissolved in ethylacetate and transferred to another RB and the solvent was evaporated under reduced pressure. The oil was further dried under vacuum. yield (17.3 g, >99%).

¹H NMR (500 MHz, Chloroform-d) δ 8.10 (d, J=7.7 Hz, 2H), 7.52-7.45 (m, 2H), 7.40 (ddd, J=7.7, 2.9, 0.9 Hz, 2H), 7.36 (d, J=8.6 Hz, 1H), 7.33 (s, 1H), 7.24 (s, 1H), 5.22 (t, J=2.9 Hz, 1H), 3.51 (td, J=11.1, 2.8 Hz, 1H), 3.38-3.31 (m, 1H), 1.82-1.69 (m, 8H), 1.47-1.30 (m, 9H), 1.20-1.11 (m, 2H), 1.07 (dd, J=10.0, 4.4 Hz, 1H), 0.85 (d, J=6.7 Hz, 48H), 0.79 (s, 9H).

¹³C NMR (126 MHz, CDCl₃) δ 151.5, 144.6, 141.5, 141.5, 136.6, 136.4, 128.2, 127.2, 126.9, 125.1, 124.7, 123.4, 123.4, 119.3, 119.3, 117.1, 116.0, 115.9, 97.2, 61.6, 57.1, 38.4, 32.6, 32.0, 32.0, 31.8, 30.0, 26.7, 26.7, 25.1, 25.0, 24.5, 24.5, 17.9.

### Synthesis of 9-(2-((tetrahydro-2H-pyran-2-yl)oxy)-3-(4,4,5,5-tetramethyl-1,3,2-dioxaborolan-2-yl)-5-(2,4,4-trimethylpentan-2-yl)phenyl)-2,7-bis(triisobutylsilyl)-9H-carbazole

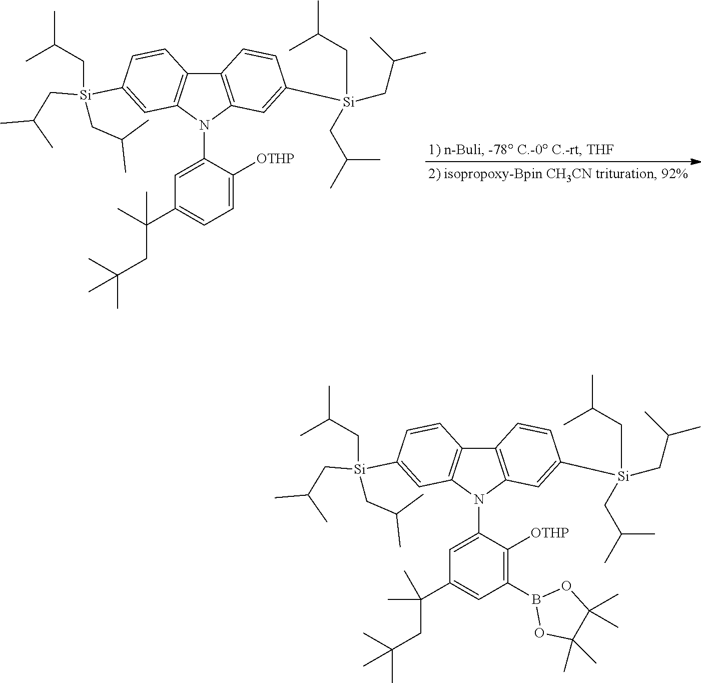

250 mL round bottom flask was charged with the 9-(2-((tetrahydro-2H-pyran-2-yl)oxy)-5-(2,4,4-trimethylpentan-2-yl)phenyl)-2,7-bis(triisobutylsilyl)-9H-carbazole (17.6.0 g, 21.0 mmol, 1.0 equiv) and 150 mL dry THF. The solution was placed under nitrogen and was cooled to −78° C. n-BuLi (2.5 M in hexane, 12.4 mL, 31 mmol, 1.5 equiv) was added dropwise. The mixture was slowly warmed to 0° C. and was allowed to stir for 2 h. Upon addition of n-BuLi, the dark brown color of the solution changed to orange, brown color. The reaction mixture was treated with isopropoxy-Bpin (8.5 mL, 41.4 mmol, 2 equiv) and stirring continued for 1 hour at 0° C. Upon addition of isopropoxy-Bpin, the color of the reaction mixture changed from orangish brown to yellow. Then the reaction mixture was stirred at room temperature for overnight. The color of the reaction turned red.

The solution was quenched with sat. sodium bicarbonate, and product was extracted with several portions of dichloromethane. The color of the organic phase was yellow. Combined organic fractions were concentrated and the dried over Na₂SO₄. The solvent was evaporated under reduced pressure. To the sticky yellow oil, 7 mL dichloromethane was added and 30 mL of acetonitrile was added and stirred the sticky oil for 30 minutes at 45° C. Then the mixture was kept in the freezer for 20 minutes. Then the supernatant was decanted and 3 portions of acetonitrile further was added to the sticky oil to wash it. The sticky oil was dissolved in 30 mL of dichloromethane and filtered through a frit funnel contains neutral alumina. Then the alumina was washed with 50 mL of dichloromethane: hexanes 1:1 mixture twice. The colorless filtrate/solution was dried under reduced pressure and kept it under vacuum for 3 h. The oil turned into a white foam. The NMR was taken in chloroform. yield (18.9 g, 92%)

¹H NMR (400 MHz, Chloroform-d) δ 8.07 (d, J=7.7 Hz, 2H), 7.87 (d, J=2.5 Hz, 1H), 7.51 (d, J=2.6 Hz, 1H), 7.45 (s, 1H), 7.42-7.35 (m, 3H), 5.01 (t, J=2.9 Hz, 1H), 2.55 (dd, J=5.8, 2.7 Hz, 2H), 1.87-1.71 (m, 8H), 1.70-1.60 (m, 1H), 1.45 (s, 3H), 1.41 (s, 3H), 1.38 (d, J=3.5 Hz, 12H), 1.30-1.19 (m, 2H), 1.19-0.99 (m, 3H), 0.93-0.81 (m, 48H), 0.76 (s, 9H).

¹³C NMR (126 MHz, CDCl₃) δ 156.6, 145.7, 140.8, 136.7, 136.3, 134.1, 130.4, 129.8, 125.0, 123.6, 123.2, 119.1, 119.1, 117.1, 116.2, 101.8, 83.7, 61.2, 57.0, 38.5, 32.6, 32.1, 32.0, 31.3, 30.0, 26.8, 26.7, 26.7, 26.7, 25.2, 25.0, 25.0, 24.7, 24.5, 18.3.

### Example 5 Synthesis of Metal-Ligand Complex 5 (MLC-5)

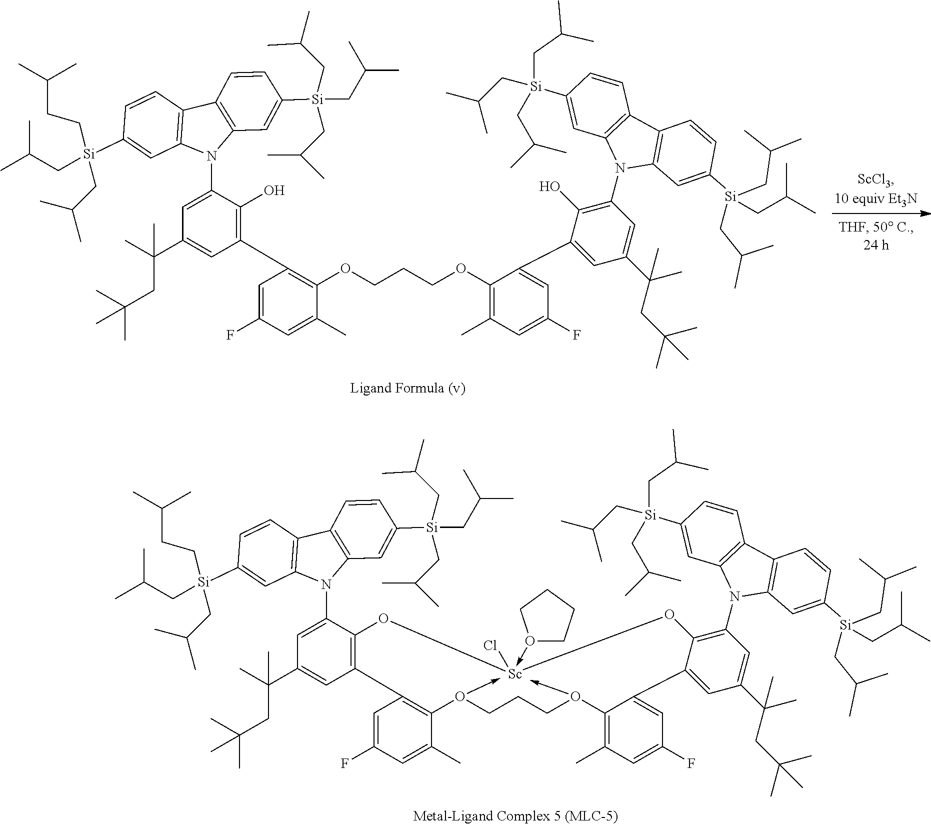

In a N₂ filled glovebox, a 20 mL vial was charged with ScCl₃ (7.6 mg, 0.050 mmol, 1.00 equiv) and 3 mL dry THF. The ligand was added (92 mg, 0.050 mmol, 1.00 equiv), followed by triethylamine (70 μL, 0.50 mmol, 10 equiv). The mixture stirred at 50° C. After 1 hour, an aliquot was removed, concentrated, and analyzed by proton/fluorine NMR to evaluate the conversion. A mixture of materials was present, indicating incomplete reaction. The reaction mixture was stirred overnight. The solution was cooled and filtered through a 0.45 μm syringe filter. The filtrate was concentrated to dryness. Proton/Fluorine NMR indicated that product was present along with some triethylamine. The solid was suspended in 2 mL hexane. A white solid precipitated, which was isolated by filtration (60.0 mg, 60%).

¹H NMR (500 MHz, Benzene-d₆) δ 8.28 (d, J=7.8 Hz, 1H), 8.22 (dd, J=7.8, 3.0 Hz, 2H), 8.18 (s, 1H), 8.07 (d, J=7.7 Hz, 1H), 7.79 (s, 1H), 7.71-7.56 (m, 7H), 7.52 (d, J=7.6 Hz, 1H), 7.38-7.26 (m, 3H), 6.96 (dd, J=8.9, 3.2 Hz, 1H), 6.43 (dd, J=8.1, 3.1 Hz, 1H), 6.22 (dd, J=8.4, 3.1 Hz, 1H), 4.43 (dd, J=9.5, 6.0 Hz, 1H), 4.03 (t, J=8.1 Hz, 1H), 3.83-3.66 (m, 2H), 3.42-3.33 (m, 2H), 3.15 (q, J=6.8 Hz, 2H), 2.07 (hept, J=6.5 Hz, 3H), 1.89 (tq, J=21.5, 6.6 Hz, 16H), 1.63-1.44 (m, 3H), 1.38 (s, 2H), 1.30-1.06 (m, 37H), 1.05-0.84 (m, 69H), 0.80 (d, J=13.7 Hz, 16H).

¹³C NMR (126 MHz, C₆D₆) δ 162.01, 161.63, 160.06, 159.67, 156.82, 156.15, 149.65, 149.63, 149.58, 149.55, 148.42, 143.54, 143.25, 142.96, 141.70, 141.62, 141.56, 138.58, 138.24, 137.89, 137.85, 137.83, 137.08, 136.59, 136.57, 136.49, 136.41, 136.07, 135.48, 135.42, 135.22, 135.15, 130.09, 129.77, 129.39, 129.34, 129.16, 129.08, 128.06, 126.73, 126.42, 126.38, 126.28, 126.10, 126.00, 125.97, 125.88, 125.78, 125.65, 125.47, 124.70, 124.24, 123.46, 120.36, 120.32, 120.17, 119.74, 119.58, 118.99, 118.18, 117.98, 117.80, 117.60, 117.42, 116.50, 116.30, 116.20, 116.12, 115.83, 115.65, 78.48, 75.49, 72.57, 71.75, 57.45, 57.06, 56.96, 38.34, 37.97, 37.91, 34.99, 34.88, 34.36, 33.25, 33.13, 32.67, 32.61, 32.28, 32.26, 32.17, 31.76, 30.89, 30.50, 30.38, 30.22, 30.17, 29.43, 27.20, 27.08, 27.06, 27.00, 26.97, 26.93, 26.84, 26.81, 25.79, 25.65, 25.52, 25.41, 25.28, 25.21, 25.16, 25.06, 24.84, 24.82, 24.74, 24.69, 23.13, 21.43, 20.89, 18.95, 18.15, 16.53, 16.35, 11.65.

¹⁹F NMR (471 MHz, Benzene-d₆) δ −115.39, −115.69.

### Synthesis of 2′,2′″-(ethane-1,2-diylbis(oxy))bis(3-(2,7-bis(triisobutylsilyl)-9H-carbazol-9-yl)-5′-fluoro-3′-methyl-5-(2,4,4-trimethylpentan-2-yl)-[1,1′-biphenyl]-2-ol)

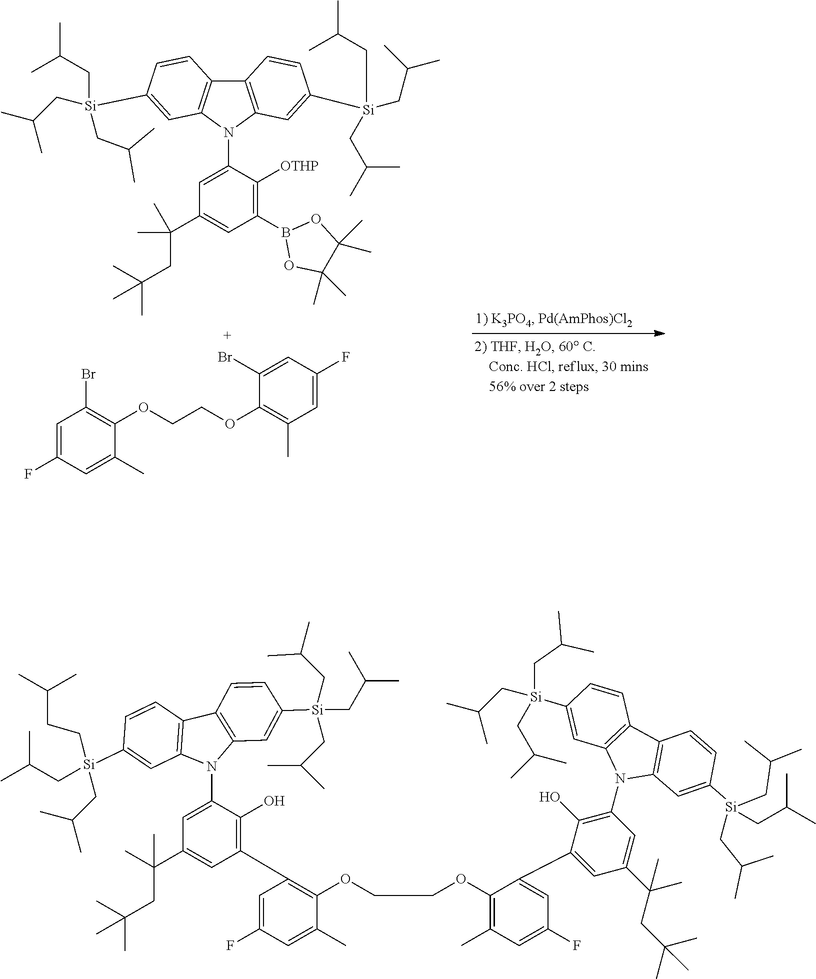

A 1 L three-neck flask was charged with 9-(2-((tetrahydro-2H-pyran-2-yl)oxy)-3-(4,4,5,5-tetramethyl-1,3,2-dioxaborolan-2-yl)-5-(2,4,4-trimethylpentan-2-yl)phenyl)-2,7-bis(triisobutylsilyl)-9H-carbazole (18.3 g, 18.6 mmol, 2.2 equiv.), 1,2-bis(2-bromo-4-fluoro-6-methylphenoxy) ethane (3.7 g, 8.5 mmol, 1 equiv.), 350 mL dry THF, and 2 (M) K₃PO₄ solution (25 mL, 61 mmol, 6 equiv.). Pd(Amphos)Cl₂ (0.30 g, 0.42 mmol, 5 mol %) was added to the solution. The reaction mixture was stirred overnight at 65° C. with a reflux condenser. The color of the solution turned brownish orange. After 16 h the reaction mixture was analyzed by proton and ¹⁹FNMR. An aliquot was taken out of the reaction mixture and filter through neutral alumina pipette. Rinsed with dichloromethane. Evaporated the solvent and NMR was taken. Suzuki double-coupled product, proto-deborylated top fragment, and something else were observed by NMR. The aqueous layer was separated from the organic layer. The organic layer was dried over Na₂SO₄. The organic layer was concentrated under reduced pressure and loaded directly onto column. The product was purified using 30% DCM in hexanes. The product came out with 20% dichloromethane in hexane. The product fractions were combined and evaporated under reduced pressure to obtain white fluffy solid

The product was dissolved in THF:MeOH mixture (2:1) 30 mL and 1 mL concentrated HCl was added, and refluxed for 40 minutes. Excess acid was quenched with 50 mL saturated NaHCO₃ solution and organic layer was extracted with dichloromethane (60 mL×3). The organic layer was dried over Na₂SO₄. The organic layer was dried under vacuum. The product was purified using 20% DCM in hexane using ISCO. The product fractions were combined and evaporated under reduced pressure to obtain white fluffy solid (8.6 g, 56% yield over 2 steps).

¹H NMR (400 MHz, Chloroform-d) δ 8.12 (d, J=7.7 Hz, 4H), 7.52-7.37 (m, 8H), 7.28 (s, 4H), 6.91 (dd, J=8.7, 3.1 Hz, 2H), 6.73 (dd, J=8.7, 3.1 Hz, 2H), 6.43 (s, 2H), 3.63 (s, 4H), 1.79 (s, 6H), 1.76-1.64 (m, 12H), 1.38 (s, 12H), 0.89-0.66 (m, 118H).

¹³C NMR (101 MHz, CDCl₃) δ 160.5, 158.0, 149.5, 149.5, 147.8, 142.9, 140.9, 137.0, 134.3, 134.2, 133.1, 133.0, 129.0, 127.5, 126.3, 126.3, 125.6, 125.4, 123.8, 119.6, 117.6, 117.4, 116.2, 116.0, 115.8, 72.3, 57.3, 38.3, 32.7, 32.1, 31.8, 26.7, 24.9, 24.6, 16.1.

¹⁹F NMR (376 MHz, CDCl₃) δ −118.10.

### Example 6—Synthesis of Metal-Ligand Complex 6 (MLC-6)

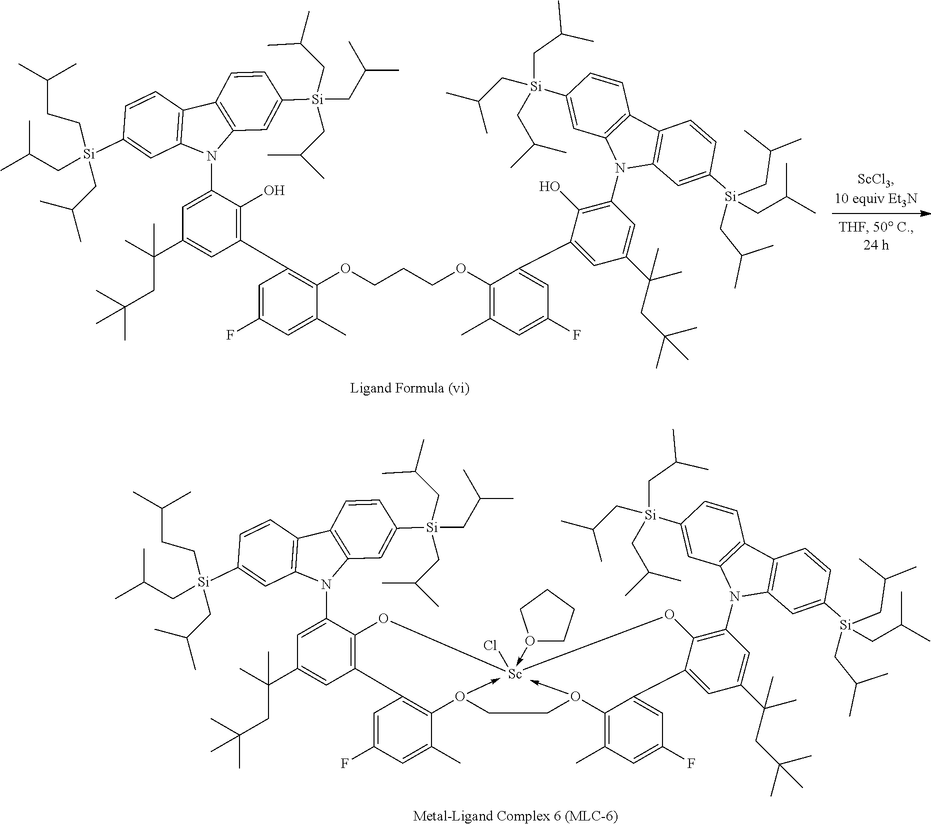

In a nitrogen-filled glovebox, an oven-dried 250 mL flask was charged with ScCl₃ (0.286 g, 1.89 mmol, 1.4 equiv). Ligand vi (2.447 g, 1.35 mmol, 1 equiv) was dissolved in THF (60 mL) and added to the ScCl3, followed by Et3N (1.88 mL, 13.51 mmol, 10 equiv). The reaction mixture was heated to 50° C. and stirred for 14 hours. The reaction was found incomplete by 1H and 19F NMR spectroscopy. Heating and stirring was continued for 4 more days. Another NMR analysis showed impure product. Additional ScCl3 (0.122 g, 0.81 mmol, 0.6 equiv) and Et₃N (1.0 mL, 7.17 mmol, 5.3 equiv) were added and the reaction was continued for 16 hours. NMR analysis showed desired product and an unknown impurity. The reaction mixture was evaporated to dryness under vacuum. The residue was extracted with 200 mL of hexanes (stirred overnight) and then filtered. The filter cake was analyzed by NMR spectroscopy and found to exclusively contain the impurity. The filtrate was evaporated to dryness under vacuum to afford the pure desired product as a white solid (1.40 g, 53%).

1H NMR (400 MHz, C₆D₆) δ 8.20 (dd, J=14.0, 7.7 Hz, 2H), 8.16-8.10 (m, 2H), 8.01 (d, J=7.7 Hz, 1H), 7.81 (s, 1H), 7.68 (s, 1H), 7.65-7.58 (m, 3H), 7.56-7.48 (m, 3H), 7.39 (dt, J=5.0, 2.8 Hz, 3H), 7.21 (dd, J=9.2, 3.2 Hz, 1H), 7.03 (dd, J=9.1, 3.3 Hz, 1H), 6.76 (dd, J=8.1, 3.1 Hz, 1H), 6.38 (dd, J=8.4, 3.1 Hz, 1H), 4.59 (td, J=10.2, 9.3, 3.7 Hz, 1H), 4.47 (td, J=10.8, 10.1, 3.4 Hz, 1H), 3.42-3.31 (m, 1H), 3.32-3.18 (m, 2H), 3.13-3.02 (m, 2H), 2.82 (dd, J=9.4, 3.3 Hz, 1H), 2.26 (s, 3H), 2.05 (ddq, J=33.2, 13.3, 6.7 Hz, 6H), 1.84 (qt, J=12.9, 6.5 Hz, 6H), 1.72-1.58 (m, 2H), 1.55 (s, 3H), 1.39 (d, J=7.9 Hz, 1H), 1.34-1.17 (m, 20H), 1.13 (dd, J=6.5, 3.5 Hz, 18H), 1.09 (dd, J=6.9, 1.7 Hz, 5H), 1.06 (d, J=6.6 Hz, 9H), 1.01 (d, J=6.6 Hz, 9H), 0.97 (dd, J=6.5, 4.7 Hz, 3H), 0.95-0.87 (m, 37H), 0.84 (dd, J=12.9, 8.0 Hz, 24H).

¹⁹F NMR (376 MHz, C₆D₆) δ −115.25, −115.65.

### Example 7—Synthesis of Metal-Ligand Complex 7 (MLC-7)

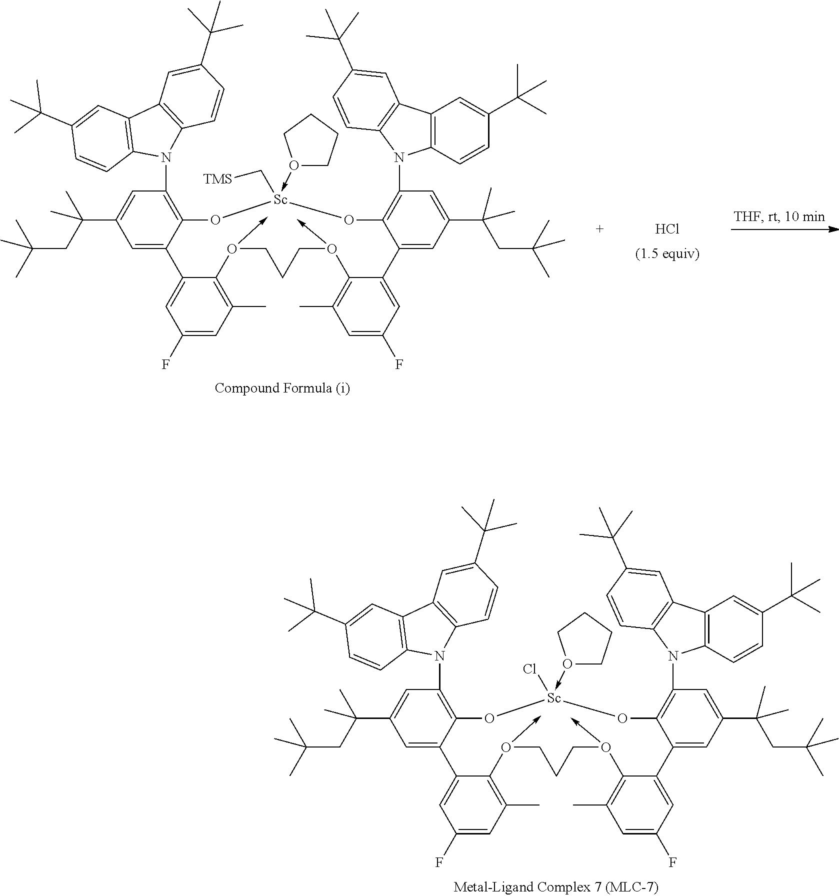

In a N₂-filled glovebox, 20 mL vial was charged with Compound Formula (i) (20 mg, 0.01, 1.0 equiv.) and 5 mL benzene-d₆. 2 (M) HCl in ether (7 μL, 0.01 mmol, 1.0 equiv.) was added to the Sc-complex and let the reaction mixture stir for 5 mins. Then an aliquot was taken from the vial and analyzed by ¹H NMR spectroscopy, which showed that an amount of Compound Formula (i) remained. The aliquot was transferred to the vial and additional 0.5 equiv. 2 (M) HCl was added to the reaction mixture and let the reaction mixture stir for 5 mins. ¹⁹F NMR analysis showed the complete consumption of Compound Formula (i) and formation of two new products, the major species identified as MLC-7.

¹H NMR (400 MHz, Benzene-d₆) δ 8.65 (d, J=1.9 Hz, 1H), 8.47 (dd, J=17.3, 1.9 Hz, 2H), 8.40 (d, J=1.9 Hz, 2H), 8.29-8.22 (m, 2H), 7.88 (dd, J=8.6, 6.1 Hz, 2H), 7.83-7.71 (m, 3H), 7.71-7.61 (m, 1H), 7.58-7.30 (m, 13H), 7.27 (t, J=3.1 Hz, 2H), 7.07 (ddd, J=8.2, 5.2, 2.6 Hz, 2H), 6.96 (dd, J=9.0, 3.3 Hz, 1H), 6.83 (dd, J=9.0, 3.2 Hz, 1H), 6.63 (td, J=8.7, 3.0 Hz, 1H), 6.31 (dd, J=8.2, 3.2 Hz, 1H), 6.08 (dd, J=8.3, 3.2 Hz, 1H), 4.02-3.89 (m, 1H), 3.75-3.29 (m, 12H), 3.28-3.11 (m, 2H), 3.11-2.94 (m, 2H), 2.55-2.02 (m, 4H), 1.86 (s, 3H), 1.80-1.06 (m, 142H), 1.06-0.54 (m, 48H).

¹⁹F NMR (376 MHz, Benzene-d₆) δ −115.42 (t, J=8.6 Hz), —116.31 (t, J=8.6 Hz), —118.13 (t, J=8.8 Hz).

### Example 8—Synthesis of Metal-Ligand Complex 8 (MLC-8)

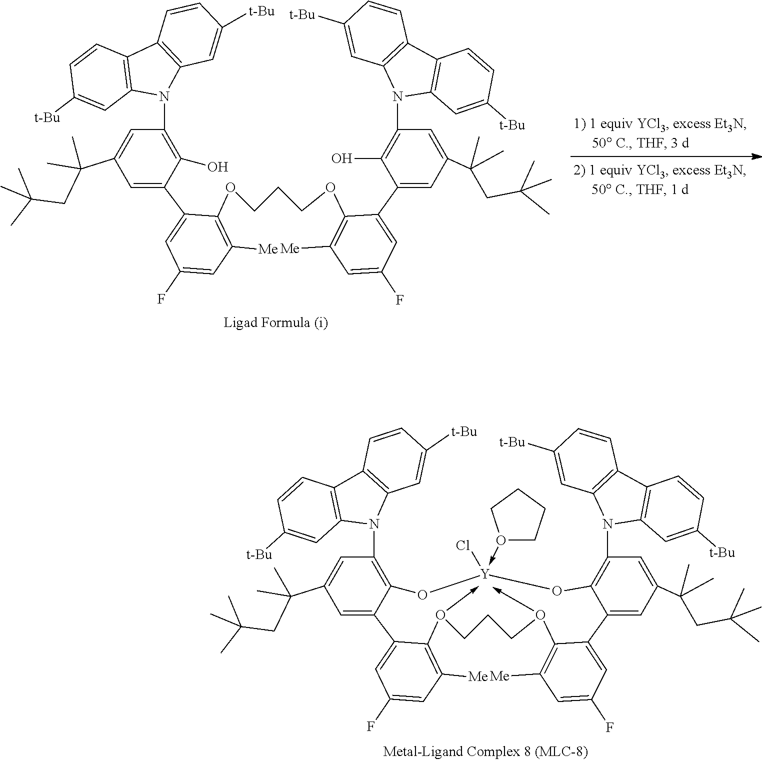

In a N₂ filled glove box a vial is charged with YCl₃ (0.048 g, 0.25 mmol), THF (ca. 10 mL), and a magnetic stir bar. The mixture was heated at 50° C. for 15 minutes, then ligand formula (i) (0.200 g, 0.159 mmol) in a THF solution (ca. 5 mL) was added, followed by an excess of Et₃N (ca. 0.30 mL, 1.6 mmol). The resulting mixture was stirred at 50° C. for 3 d, after which time a second equivalent of YCl₃ was added, followed by an excess of Et₃N (ca. 0.30 mL, 1.6 mmol). The mixture was stirred at 50° C. overnight and then the solvent was removed in vacuo and the complex was extracted with pentane and passed over a fritted column. The solvent was removed in vacuo to afford MLC-8 as a white solid (175 mg, 76% yield).

¹H NMR (400 MHz, Benzene-d₆) δ 8.24 (dd, J=8.3, 5.9 Hz, 2H), 8.15 (d, J=8.2 Hz, 1H), 8.01 (s, 1H) 7.94 (d, J=8.2 Hz, 1H), 7.73 (d, J=2.6 Hz, 1H), 7.62 (s, 1H), 7.57-7.41 (m, 5H), 7.39 (s, 1H), 7.26 (m, 2H), 7.21 (d, J=8.1 Hz, 1H), 7.00 (dd, J=9.0, 3.1 Hz, 1H), 6.90 (dd, J=9.0, 3.1 Hz, 1H), 6.24 (dd, J=8.0, 3.1 Hz, 1H), 6.04 (dd, J=8.7, 3.1 Hz, 1H), 3.82 (t, J=9.7 Hz, 1H), 3.77 (s, 1H), 3.59 (t, J=9.6 Hz, 1H), 3.36 (t, J=8.4 Hz, 1H), 3.03-2.95 (m, 2H), 2.65-2.57 (m, 2H), 1.92-1.83 (m, 1H), 1.73-1.61 (m, 3H), 1.61 (s, 9H), 1.57 (s, 3H), 1.56-0.99 (obscured, 9H), 1.47 (s, 9H), 1.38 (s, 3H), 1.29 (s, 9H), 1.25 (s, 3H), 1.19 (s, 9H), 1.17 (s, 3H), 1.06 (s, 3H), 0.89 (s, 9H), 0.86 (s, 9H).

¹⁹F NMR (376 MHz, Benzene-d₆) δ −114.55 (t, J=8.9 Hz), —115.09 (t, J=8.9 Hz).

### Example 9—Synthesis of Metal-Ligand Complex 9 (MLC-9)

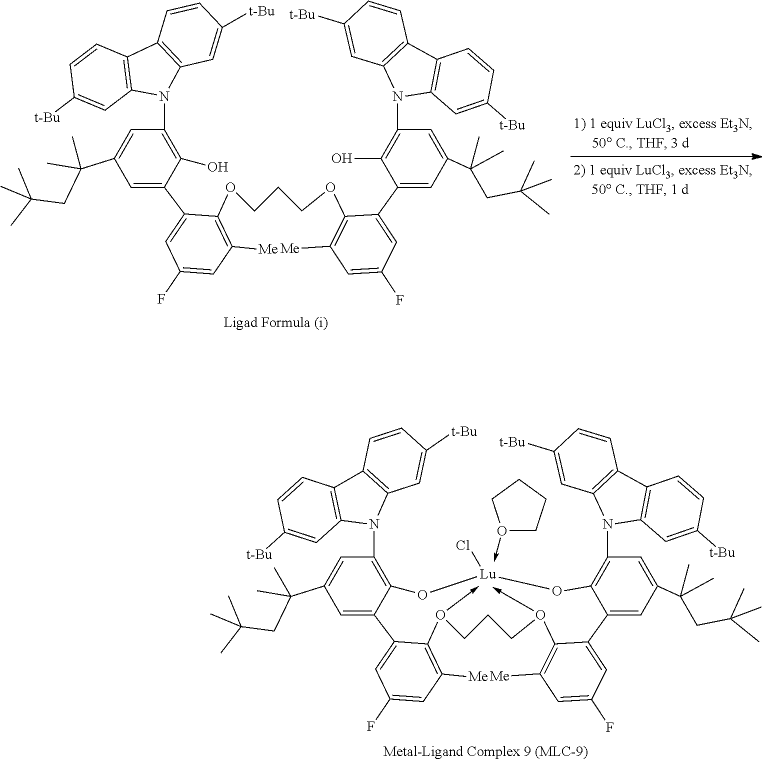

In a glove box a vial is charged with LuCl₃ (0.045 g, 0.16 mmol), THF (ca. 10 mL), and a magnetic stir bar. The mixture was heated at 50° C. for 15 minutes, then ligand formula (i) (0.200 g, 0.159 mmol) in a THF solution (ca. 5 mL) was added, followed by an excess of Et₃N (ca. 0.30 mL). The resulting mixture was stirred at 50° C. for 3 d, after which time a second aliquot of LuCl₃ (0.50 g, 0.18 mmol) was added, followed by an excess of Et₃N (ca. 0.50 mL). The mixture was stirred at 50° C. overnight and then the solvent was removed in vacuo and the complex was extracted with pentane and passed over a fritted column. The solvent was removed in vacuo to afford MLC-9 as a white solid.

¹H NMR (400 MHz, Benzene-d₆) δ 8.23 (t, J=7.8 Hz, 2H), 8.13 (d, J=8.2 Hz, 1H), 7.99 (d, J=1.7 Hz, 1H), 7.93 (d, J=8.2 Hz, 1H), 7.75 (d, J=2.6 Hz, 1H), 7.61 (d, J=1.7 Hz, 1H), 7.53 (m, 2H), 7.50-7.39 (m, 3H), 7.36 (d, J=1.6 Hz, 1H), 7.26 (dd, J=12.4, 2.6 Hz, 2H), 7.20 (dd, J=8.3, 1.7 Hz, 1H), 7.00 (dd, J=8.9, 3.2 Hz, 1H), 6.87 (dd, J=8.9, 3.2 Hz, 1H), 6.24 (dd, J=8.2, 3.2 Hz, 1H), 6.05 (dd, J=8.6, 3.2 Hz, 1H), 3.92-3.77 (m, 2H), 3.64-3.55 (m, 1H), 3.38 (m, 1H), 3.03 (dt, J=8.2, 6.1 Hz, 2H), 2.65 (dt, J=8.0, 6.1 Hz, 2H), 1.91-1.74 (m, 2H), 1.74-1.64 (m, 2H), 1.63 (s, 3H), 1.62 (s, 9H), 1.60-1.45 (m, 2H), 1.46 (s, 9H), 1.29 (s, 3H), 1.28 (s, 9H), 1.26-1.21 (m, 2H), 1.193 (s, 3H), 1.186 (s, 9H), 1.17 (s, 3H), 1.03 (s, 3H), 1.02-0.92 (m, 2H), 0.89 (s, 9H), 0.86 (s, 9H)-0.78 (m, 2H).

¹⁹F NMR (376 MHz, Benzene-d₆) δ −115.01 (t, J=8.6 Hz), —115.11 (t, J=8.6 Hz).

### Example 10—Synthesis of Metal-Ligand Complex 10 (MLC-10)

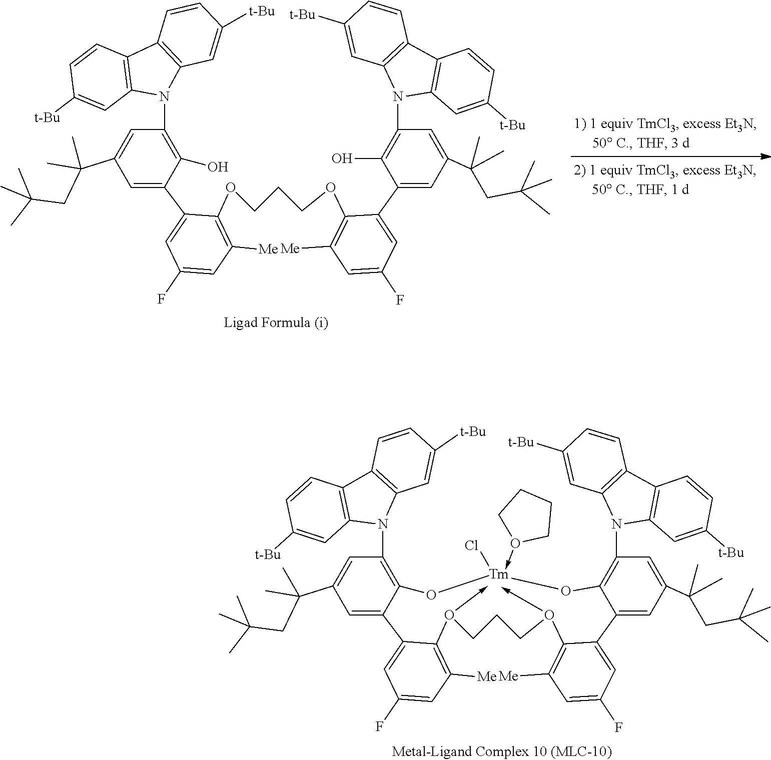

In a N₂ filled glove box a vial was charged with TmCl₃ (0.054 g), THF (ca. 10 mL), and a magnetic stir bar. The mixture was heated at 50° C. for 15 minutes, then ligand formula (i) (0.200 g, 0.159 mmol) in a THF solution (ca. 5 mL) was added, followed by an excess of Et₃N (ca. 0.30 mL). The resulting mixture was stirred at 50° C. for 3 d, after which time a second aliquot of TmCl₃ (0.77 g, 0.16 mmol) was added, followed by an excess of Et₃N (ca. 0.50 mL). The mixture was stirred at 50° C. overnight and then the solvent was removed in vacuo and the complex was extracted with pentane and passed over a fritted column. The solvent was removed in vacuo to afford MLC-10 as a white solid (199 mg).

MLC-10 is a paramagnetic compound: ¹H NMR (400 MHz, Benzene-d₆) signals from δ 350 to −242 ppm.

¹⁹F NMR (376 MHz, Benzene-d₆) δ −42.36 (s), —57.37 (s).

### Example 11—Synthesis of Metal-Ligand Complex 11 (MLC-11)

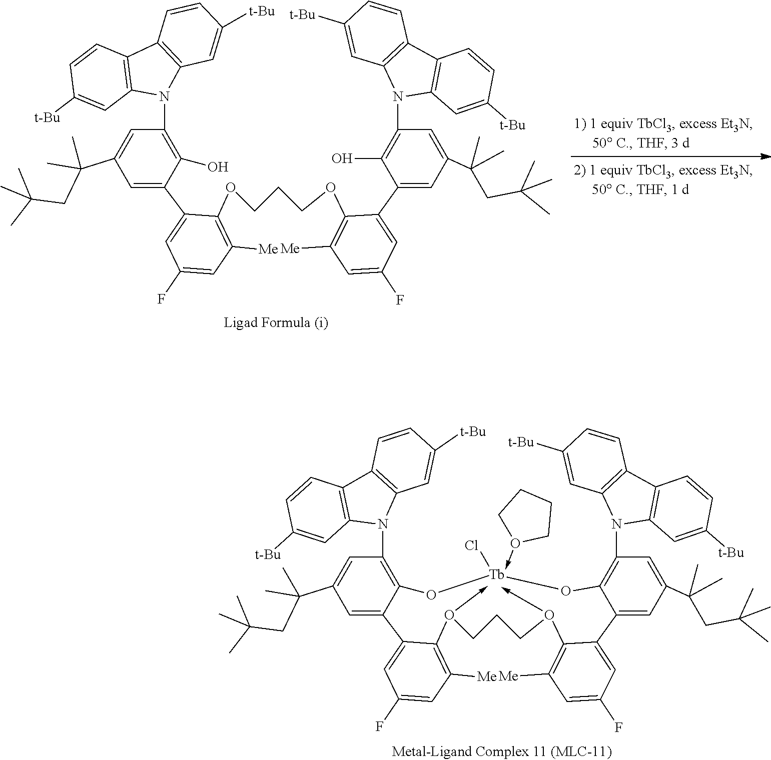

In a N₂ filled glove box a vial is charged with TbCl₃ (0.051 g, 0.19 mmol), THF (ca. 7 mL), and a magnetic stir bar. The mixture was heated at 50° C. for 15 minutes, then ligand formula (i) (0.205 g, 0.163 mmol) in a THF solution (ca. 5 mL) was added, followed by an excess of Et₃N (ca. 0.30 mL). The resulting mixture was stirred at 50° C. for 3 d, after which time a sample was taken and analyzed by 19F NMR spectroscopy, revealing the presence of both Ligand Formula (i) and Metal-Ligand Complex 11. A second aliquot of TbCl₃ (0.079 g, 0.30 mmol) was added, followed by an excess of Et₃N (ca. 0.50 mL). The mixture was stirred at 50° C. overnight and then the solvent was removed in vacuo and the complex was extracted with pentane and passed over a fritted column. The solvent was removed in vacuo to afford MLC-11 as a white solid (232 mg, 94% yield).

MLC-11 is a paramagnetic compound: ¹H NMR (400 MHz, Benzene-d₆) signals from δ 140 to −375 ppm.

¹⁹F NMR (376 MHz, Benzene-d₆) δ −143.67 (s), —175.09 (s).

### Example 12—Synthesis of Metal-Ligand Complex 12 (MLC-12)

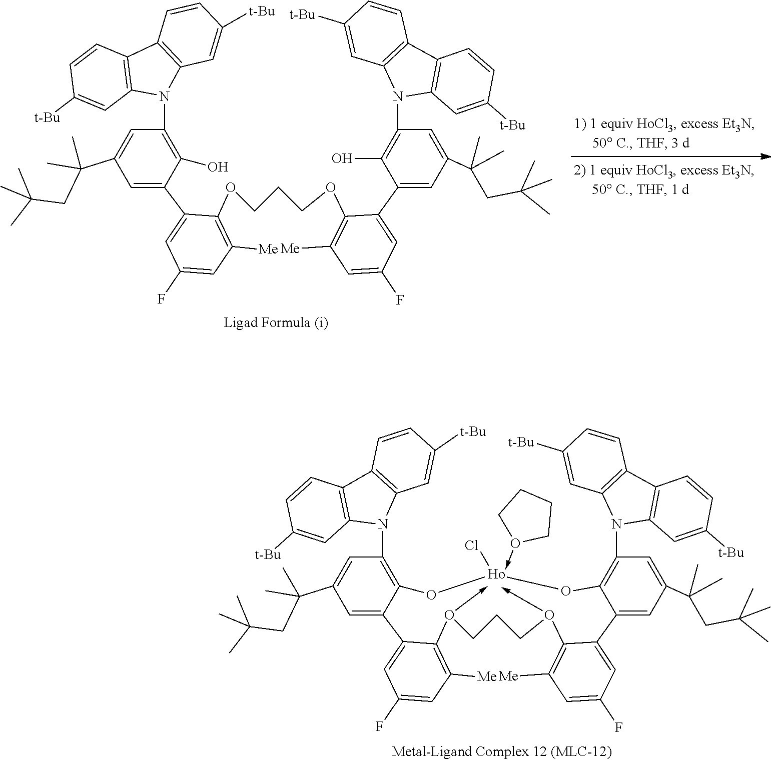

In a N₂ filled glove box a vial is charged with HoCl₃ (0.050 g, 0.18 mmol), THF (ca. 7 mL), and a magnetic stir bar. The mixture was heated at 50° C. for 15 minutes, then ligand formula (i) (0.202 g, 0.161 mmol) in a THF solution (ca. 5 mL) was added, followed by an excess of Et₃N (ca. 0.30 mL). The resulting mixture was stirred at 50° C. for 3 d, after which time a second aliquot of HoCl₃ (0.050 g, 0.18 mmol) was added, followed by an excess of Et₃N (ca. 0.50 mL). The mixture was stirred at 50° C. overnight and then the solvent was removed in vacuo and the complex was extracted with pentane and passed over a fritted column. The solvent was removed in vacuo to afford MLC-12 as a white solid (228 mg, 93% yield).

MLC-12 is a paramagnetic compound: ¹H NMR (400 MHz, Benzene-d₆) signals from δ 168 to −212 ppm.

¹⁹F NMR (376 MHz, Benzene-d₆) δ −143.36 (s), —175.48 (s).

The Comparative metal-ligand complexes C1 and C2 (herein “Comparative C1” and “Comparative C2”) were each intermixed with Co-catalyst 1 to form a catalyst system. The inventive metal-ligand complexes 1-12 have a structure according to the metal-ligand complex of formula (I). The Comparative Procatalysts had the following structures and their preparation was reported in WO2021155158 A1

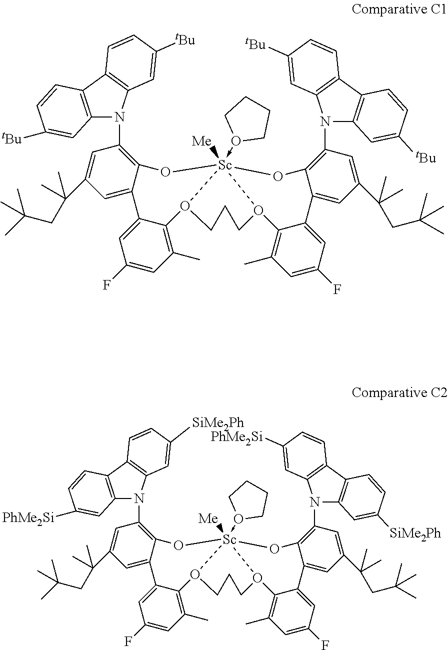

### Example 13—Batch Reactor Polymerization Results

Procedure for Batch Reactor Polymerization. The batch reactor polymerization reactions are conducted in a 2 L Parr™ batch reactor. The reactor is heated by an electrical heating mantle, and is cooled by an internal serpentine cooling coil containing cooling water. Both the reactor and the heating/cooling system are controlled and monitored by a Camile™ TG process computer. The bottom of the reactor is fitted with a dump valve that empties the reactor contents into a stainless steel dump pot. The dump pot is optionally prefilled with a catalyst kill solution (typically 5 mL of an Irgafos/Irganox/toluene mixture). The dump pot is vented to a 30 gallon blow-down tank, with both the pot and the tank purged with nitrogen. All solvents used for polymerization or catalyst makeup are run through solvent purification columns to remove any impurities that may affect polymerization. The 1-octene and IsoparE are passed through two columns, the first containing A2 alumina, the second containing Q5. The ethylene is passed through two columns, the first containing A204 alumina and 4 \acute{Å} molecular sieves, the second containing Q5 reactant. The N₂, used for transfers, is passed through a single column containing A204 alumina, 4 \acute{Å} molecular sieves and Q5.

The reactor is loaded first from the shot tank that may contain IsoparE solvent and/or 1-octene, depending on reactor load. The shot tank is filled to the load set points by use of a lab scale to which the shot tank is mounted. After liquid feed addition, the reactor is heated up to the polymerization temperature set point. If ethylene is used, it is added to the reactor when the ethylene is at the reaction temperature to maintain reaction pressure set point. The amount of ethylene added is monitored by a micro-motion flow meter. For some experiments, the standard conditions at 120° C. are 46 g ethylene and 303 g 1-octene in 611 g of IsoparE, and the standard conditions at 150° C. are 43 g ethylene and 303 g 1-octene in 547 g of IsoparE.

The metal-ligand complex and co-catalyst are mixed with the appropriate amount of purified toluene to achieve a molarity solution. The metal-ligand complex and co-catalyst are handled in an inert glove box, drawn into a syringe and pressure transferred into the catalyst shot tank. The syringe is rinsed three times with 5 mL of toluene. Immediately after the catalyst is added, the run timer begins. If ethylene is used, it is added by the Camile to maintain reaction pressure set point in the reactor. The polymerization reactions are run for 10 minutes, then the agitator is stopped, and the bottom dump valve is opened to empty reactor contents to the dump pot. The contents of the dump pot are poured into trays and placed in a lab hood where the solvent was evaporated off overnight. The trays containing the remaining polymer are transferred to a vacuum oven, where they are heated up to 140° C. under vacuum to remove any remaining solvent. After the trays cool to ambient temperature, the polymers were weighed for yield to measure efficiencies, and submitted for polymer testing. The results of the high 1-octene polymerization reactions are shown in Table 1.

TABLE 1
Summary of Batch Reactor Results for MLC-1 and MLC-2.

| | | Co- | | Catalyst | | Efficiency | | | | | |
|---|---|---|---|---|---|---|---|---|---|---|---|
| Ex. | | Catalyst/ | Co-Cat. | Loading | Yield | (kg poly/ | Mₙ | M_{w} | | wt % | Tm |
| No. | Catalyst | Additive | (equiv) | (μmol) | (g) | gM) | (kg/mol) | (kg/mol) | M_{w}/Mₙ | octene | (° C.) |
| Ex. 1 | IMLC-1 | MMAO^{[a]} | 150 | 1.5 | 29.7 | 440 | 44.4 | 84.3 | 1.90 | ND | 132.1 |
| Ex. 2 | IMLC-1 | MMAO^{[b]} | 150 | 1.45 | 29.0 | 445 | 39.5 | 83.2 | 2.11 | ND | 132.7 |
| Ex. 3 | IMLC-1 | MMAO^{[a]} | 20 | 2.75 | 4.1 | 33 | 58.7 | 126.7 | 2.14 | ND | 132.4 |
| Ex. 4 | Comp. C1 | MMAO^{[a]} | 150 | 0.975 | 15.6 | 356 | 48.9 | 97.6 | 1.99 | ND | 133.1 |
| Ex. 5 | IMLC-2 | MMAO^{[a]} | 150 | 1.0 | 21.6 | 480 | 76.6 | 182.2 | 2.38 | ND | 132.1 |
| Ex. 6 | IMLC-2 | MMAO^{[b]} | 150 | 1.5 | 22.7 | 337 | 67.1 | 162.0 | 2.41 | ND | 132.2 |
| Ex. 7 | Comp. C2 | MMAO^{[b]} | 50 | 1.15 | 9.3 | 180 | 77.6 | 161.8 | 2.09 | ND | 132.5 |

Reactor conditions for Table 1:190° C., 410 psi C2, 65 g 1-octene, 1250 g isopar-E, 10 min. run time. ND-below detection limit of the instrument. ^{[a]}Co-catalyst/additive was mixed with catalyst before injection. ^{[b]}Co-catalyst/additive was added to polymerization prior to catalyst injection.

In example 1 inventive metal-ligand complex 1 (IMLC-1) is mixed with a modified MMAO co-catalyst prior to injection to activate the precatalyst. In example 2 the MMAO-co-catalyst is fed into the reactor separately and before the precatalyst, which is then injected into the reactor. Both show the same efficiency and same polymer is produced indicating a fast activation of precatalyst. In example 3 IMLC-1 is premixed with 20 equiv. of MMAO and fed into the reactor, the efficiency is very low indicating a dependence on the MMAO to activate the catalyst. A low level of MMAO was selected to show low reactivity rather than using no MMAO because the MMAO acts as a scavenger as well and prevents poisoning of the IMLC-1 by impurities (hence preventing a false negative result). Example 4 uses the same conditions as example 1, but with the comparative catalyst, which is synthesized as a pre-activated catalyst with an alkyl leaving group. The efficiency of the comparative catalyst is somewhat lower than the IMLC-1 with co-catalyst and the same polymer is made.

### Example 14—Continuous Process Polymerization Results

Raw materials (ethylene, 1-octene) and the process solvent (a narrow boiling range high-purity isoparaffinic solvent trademarked Isopar E commercially available from ExxonMobil Corporation) are purified with molecular sieves before introduction into the reaction environment. Hydrogen is supplied in pressurized cylinders as a high purity grade and is not further purified. The reactor monomer feed (ethylene) stream is pressurized via mechanical compressor to above reaction pressure at 525 psig. The solvent and comonomer (1-octene) feed is pressurized via mechanical positive displacement pump to above reaction pressure at 525 psig. Triethylaluminum (TEA) and modified methylaluminoxane (MMAO), commercially available from AkzoNobel, are used as co-catalysts and each can alternately function as an impurity scavenger. The individual catalyst components (procatalyst cocatalyst) are manually batch diluted to specified component concentrations with purified solvent (Isopar E) and pressured to above reaction pressure at 525 psig. All reaction feed flows are measured with mass flow meters and independently controlled with computer automated valve control systems.

The continuous solution polymerizations are carried out in a 5 L continuously stirred-tank reactor (CSTR). The reactor has independent control of all fresh solvent, monomer, comonomer, hydrogen, and catalyst component feeds. The combined solvent, monomer, comonomer and hydrogen feed to the reactor is temperature controlled to anywhere between 5° C. to 50° C. and typically 25° C. The fresh comonomer feed to the polymerization reactor is fed in with the solvent feed. The fresh solvent feed is controlled typically with each injector receiving half of the total fresh feed mass flow. A 6.0 mmol/kg solution of co-catalyst 1 is fed at a rate of 56.6 g/h while a 16.0 mmol/kg solution of co-catalyst 2 is fed at a rate of 65.44 g/h. Immediately following each fresh injection location, the feed streams are mixed with the circulating polymerization reactor contents with static mixing elements. The effluent from the polymerization reactor (containing solvent, monomer, comonomer, hydrogen, catalyst components, and molten polymer) exits the first reactor loop and passes through a control valve (responsible for maintaining the pressure of the first reactor at a specified target). As the stream exits the reactor it is contacted with water to stop the reaction. In addition, various additives such as anti-oxidants, can be added at this point. The stream then goes through another set of static mixing elements to evenly disperse the catalyst kill and additives.

Following additive addition, the effluent (containing solvent, monomer, comonomer, hydrogen, catalyst components, and molten polymer) passes through a heat exchanger to raise the stream temperature in preparation for separation of the polymer from the other lower boiling reaction components. The stream then enters a two stage separation and devolatization system where the polymer is removed from the solvent, hydrogen, and unreacted monomer and comonomer. The separated and devolatized polymer melt is pumped through a die specially designed for underwater pelletization, cut into uniform solid pellets, dried, and transferred into a box for storage.

TABLE 2
Continuous Process Ethylene/1-Octene Copolymerization Reaction with MLC-6.

| | | Co- | Co- | % | H₂ | C2 | | | MI | | Reactivity |
|---|---|---|---|---|---|---|---|---|---|---|---|
| | Temp. | Catalyst | Catalyst | Solids | (mol | conversion | | I₁₀/ | (g/10 | Density | Ratio |
| Catalyst | (° C.) | 1 | 2 | (%)^{[A]} | %)^{[B]} | (%) | Eff.^{[C]} | I₂ | min) | (g/cc) | (r₁) |
| MLC-6 | 190 | TEA | MMAO | 16.64 | 0.11 | 91.37 | 4.04 | 5.5 | 3.16 | 0.9502 | 900 |

Continuous reactor conditions: solvent feed=21.28 kg/h, ethylene feed=4.87 kg/h, 1-octene feed 2.09 kg/h, ethylene exit=8.53 g/L, and Al concentration=1 ppm. ^{[A]}% Solids is the concentration of polymer in the reactor. ^{[B]}H₂ (mol %) is defined as the mole fraction of hydrogen, relative to ethylene, fed into the reactor. ^{[C]}The efficiency (Eff.) is measured as 10⁶ g polymer/g Metal).

### Equipment Standards

All solvents and reagents are obtained from commercial sources and used as received unless otherwise noted. Anhydrous toluene, hexanes, tetrahydrofuran, and diethyl ether are purified via passage through activated alumina and, in some cases, Q-5 reactant. Solvents used for experiments performed in a nitrogen-filled glovebox are further dried by storage over activated 4 Å molecular sieves. Glassware for moisture-sensitive reactions is dried in an oven overnight prior to use. NMR spectra are recorded on Varian 400-MR and VNMRS-500 spectrometers. Chemical shifts for ¹H NMR data are reported in ppm downfield from internal tetramethylsilane (TMS, δ scale) using residual protons in the deuterated solvent as references. ¹³C NMR data are determined with ¹H decoupling, and the chemical shifts are reported downfield from tetramethylsilane (TMS, δ scale) in ppm versus the using residual carbons in the deuterated solvent as references.

1. A polymerization process comprising:
polymerizing ethylene and optionally one or more olefins in the reactor system comprising one or multiple reactors in the presence of a catalyst system comprising one or more olefin polymerization catalysts including at least one derived from one metal-ligand complex of formula (I), alkylating agent, and optionally a Lewis Acid, under olefin polymerizing conditions to form an ethylene-based polymer: 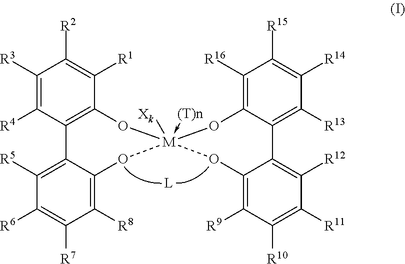
where:
M is scandium, yttrium, or a lanthanide metal having an oxidation state of +3;
X is a halogen;
each T is independently Lewis Base;
n is 0, 1, or 2;
k is 1 or 2;
the metal-ligand complex is overall charge-neutral;
R¹ and R¹⁶ are independently selected from the group consisting of (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, or halogen;
R², R³, R⁴, R⁵, R⁶, R⁷, R⁸, R⁹, R¹⁰, R¹¹, R¹², R¹³, R¹⁴, and R¹⁵ are independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂—OR^{C}, —SR^{C}, —NO₂, —CN, —CF₃, R^{C}S(O)—, R^{C}S(O)₂—, (R^{C})₂C═N—, (R^{C})₂P═N—, R^{C}C(O)O—, R^{C}OC(O)—, R^{C}C(O)N(R)—, (R^{C})₂NC(O)—, and halogen;
provided that when M is yttrium or a lanthanide metal, R¹ is not —H, phenyl or tert-butyl; and R¹⁶ is not —H, phenyl or tert-butyl;
L is (C₁-C₄₀)hydrocarbylene or (C₁-C₄₀)heterohydrocarbylene; and
each R^{C}, R^{P}, and R^{N} in formula (I) is independently a (C₁-C₃₀)hydrocarbyl, (C₁-C₃₀)heterohydrocarbyl, or —H.

2. The polymerization process of claim 1, wherein the alkylating agent is modified aluminoxane.

3. The polymerization process of claim 1, wherein the alkylating agent is alkyl aluminum.

4. The polymerization process of claim 1, wherein the alkylating agent is alkyl magnesium.

5. The polymerization process of claim 1, wherein the Lewis Acid co-catalyst is alkyl aluminum having a formula of AlR^{A}₃, where each R^{A} is independently (C₁-C₄₀)hydrocarbyl.

6. The polymerization process of claim 5, wherein each R^{A} is independently (C₁-C₄₀)alkyl.

7. The polymerization process of claim 1, wherein the Lewis Acid comprises (A) at least one co-catalyst is selected from an aluminoxane or (B) at least one co-catalyst selected from an alkyl aluminum of the formula AlR¹R²R³ or (C) at least one co-catalyst is selected from an aluminoxane and at least one activator selected from an alkyl aluminum of the formula AlR¹R²R³.

8. The polymerization process of claim 1, wherein at least one Lewis Acid co-catalyst is selected from the mixture of alkyl aluminum compound and alky zinc compound.

9. The polymerization process of claim 1, wherein at least one Lewis Acid is selected from the mixture of alkyl aluminum compound and boron-based Lewis Acid.

10. The polymerization process of claim 1, wherein polymerization process occurs in a single reactor.

11. The polymerization process of claim 10, wherein with catalyst system further comprises at least one group IV catalyst.

12. The polymerization process of claim 1,
wherein the polymerization process occurs in multiple reactors.

13. The polymerization process of claim 12, wherein the catalyst system further comprises at least one group IV catalyst.

14. The polymerization process according to claim 1, where R¹ and R¹⁶ are chosen from radicals having formula (II), radicals having formula (III), and radicals having formula (IV): 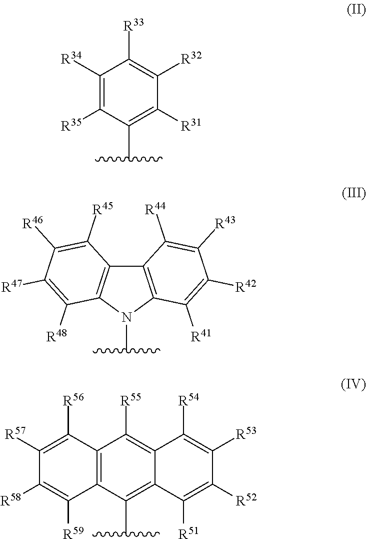
where each of R³¹⁻³⁵, R⁴¹⁻⁴⁸, and R⁵¹⁻⁵⁹ is independently chosen from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen; provided that when R¹ and R¹⁶ are formula (II), at least one of R³¹ to R³⁵ is not —H.

15. The polymerization process according to claim 1, wherein when M is scandium, yttrium or a lanthanide metal, at least one of R⁵⁻⁸ is not —H and at least one of R⁹⁻¹² is not —H.

16. The polymerization process according to claim 1, wherein at least one of R¹ and R¹⁶ is a radical having formula (III), wherein:
R⁴² and R⁴⁷ are (C₁-C₂₀)hydrocarbyl, —Si[(C₁-C₂₀)hydrocarbyl]₃, or —Ge[(C₁-C₂₀)hydrocarbyl]₃; or
R⁴³ and R⁴⁶ are (C₁-C₂₀)hydrocarbyl, —Si[(C₁-C₂₀)hydrocarbyl]₃, or —Ge[(C₁-C₂₀)hydrocarbyl]₃.

17. The polymerization process according to claim 1, wherein at least one of R¹ and R¹⁶ is a radical having formula (II), wherein:
at least one of R³¹ to R³⁵ is not —H: or
R³² and R³⁴ are (C₁-C₂₀)hydrocarbyl, —Si[(C₁-C₂₀)hydrocarbyl]₃, or —Ge[(C₁-C₂₀)hydrocarbyl]₃.

18. The polymerization process according to claim 1, wherein at least one of R¹ and R¹⁶ is a radical having formula (IV), wherein:
at least two of R⁵², R⁵³, R⁵⁵, R⁵⁷, and R⁵⁸ are (C₁-C₂₀)hydrocarbyl, Si[(C₁-C₂₀)hydrocarbyl]₃, or —Ge[(C₁-C₂₀)hydrocarbyl]₃; and
optionally R⁵² and R⁵³ are linked to form a cyclic structure, and optionally R⁵⁷ and R⁵⁸ are linked to form a cyclic structure.

19. The metal-ligand complex according to claim 1, where L is chosen from —CH₂—, CH₂ (CH₂)ₘCH₂— where m is from 0 to 3, —CH₂Si(R^{C})₂CH₂, —CH₂Ge(R^{C})₂CH₂—, —CH(CH₃)CH₂CH*(CH₃), and —CH₂ (phen-1,2-di-yl)CH₂—, where each R^{C} in L is (C₁-C₂₀)hydrocarbyl, and “C*” is a carbon atom from which a hydrogen atom is removed to form a secondary or tertiary alkyl radical.

20. The metal-ligand complex according to claim 1, wherein n is 1 or 2; and at least one T is (C₁-C₂₀)heterohydrocarbon, wherein the hetero atom of the heterohydrocarbon is oxygen.

21. The metal-ligand complex according to claim 1, wherein n is 1 or 2; and at least one T is tetrahydrofuran, diethyl ether, or methyl tert-butyl ether (MTBE).

22. The metal-ligand complex according to claim 1, wherein:
R², R⁴, R⁵, R¹², R¹³, and R¹⁵ are hydrogen.
